(19) United States
(12) Patent Application Publication
(10) Pub. No.: US 2014/0059326 A1
(43) Pub. Date: Feb. 27, 2014

(54) CALCULATION PROCESSING DEVICE AND CALCULATION PROCESSING DEVICE CONTROLLING METHOD

(71) Applicant: FUJITSU LIMITED, Kawasaki-shi (JP)

(72) Inventors: Sota SAKASHITA, Kawasaki (JP); Yasunobu Akizuki, Kawasaki (JP); Toshio Yoshida, Tokorozawa (JP)

(21) Appl. No.: 13/921,542

(22) Filed: Jun. 19, 2013

(30) Foreign Application Priority Data
Aug. 24, 2012 (JP) 2012-185493

(51) Int. Cl. G06F 9/30

(52) U.S. Cl. CPC G06F 9/30003
USPC 712/208

(57) ABSTRACT

A calculation-processing-device includes: a decoder unit including, a first-counter to increment a first-count-value and to decrement the-first-count-value, and a second-counter configured to increment a second-count-value and to decrement the second-count-value; a first-instruction-executing-unit to execute an instruction of the first-class; a second-instruction-executing-unit to execute an instruction of the-second class; a first-instruction holding unit including a plurality of first-entries, to input the instruction of the first-class held in one of the plurality of first-entries into the first-instruction-executing-unit; a second-instruction-holding-unit including a plurality of second-entries, to input the instruction of the second-class held in one of the plurality of second-entries into the second-instruction-executing-unit; and first-control-unit to output the second-release-notification, and to change the output timing of the second-release-notification when a predetermined relationship is established between the first-timing and the second-timing, and the register is used by the subsequent instruction of the second-class.

### CROSS-REFERENCE TO RELATED APPLICATION(S)

This application is based upon and claims the benefit of priority of the prior Japanese Patent Application No. 2012-185493, filed on Aug. 24, 2012, the entire contents of which are incorporated herein by reference.

### FIELD

The embodiments discussed herein are related to a calculation processing device and method for controlling a calculation processing device.

### BACKGROUND

Calculation processing devices such as processors having pipelines for dividing and executing instructions into multiple stages store instructions supplied from a decoder unit, for example, and have a reservation station for outputting executable instructions in sequence to an executing unit. This reservation station increases efficiency of instruction execution by changing the sequence of instructions to be executed.

For calculation processing devices having multiple reservation stations and multiple calculating units, methods have been proposed to reduce the number of instructions in one reservation unit as compared to another reservation station (refer to Japanese Laid-open Patent Publication No. 2004-30424).

Such methods decrease the frequency of cross-path bypassing to output the calculation result of one calculating unit to another calculating unit, which shortens the processing time of instructions.

For example, in a case of read data stored in a register from a storage device by executing a load instruction being used by a subsequent instruction following execution of the load instruction, the processing efficiency of instructions may be improved by bypassing the read data to a calculating unit during a cycle in which the read data is stored in the register. In this way, bypassing of the read data is executed in a case where a register used by a load instruction and a subsequent instruction is same (a case where there is a dependent relationship regarding registers between instructions). On the other hand, in a case where the load instruction and subsequent instruction use different registers, bypass processing is not executed.

For example, in a case where there is a dependent relationship regarding registers between instructions, the subsequent instruction held at a reservation station is disabled based on completion of the load instruction and execution of the subsequent instruction.

If there is no dependent relationship regarding registers between instructions, and the subsequent instruction held at a reservation station is disabled based on completion of the load instruction and execution of the subsequent instruction, the timing of disabling is later as compared to a case of not waiting for completion of the load instruction.

It has been found desirable to change output timing of a second release notification, in accordance with timings of completion of first and second types of instructions, and dependence relationship regarding registers, so as to raise the frequency at which the decrementing timing of a second counter is earlier, as compared with the related art, and to improve usage efficiency of a second instruction holding unit.

### SUMMARY

According to an aspect of the invention, A calculation-processing-device includes: a decoder unit including, a first-counter to increment a first-count-value and to decrement the-first-count-value, and a second-counter configured to increment a second-count-value and to decrement the second-count-value; a first-instruction-executing-unit to execute an instruction of the first-class; a second-instruction-executing-unit to execute an instruction of the-second class; a first-instruction holding unit including a plurality of first-entries, to input the instruction of the first-class held in one of the plurality of first-entries into the first-instruction-executing-unit; a second-instruction-holding-unit including a plurality of second-entries, to input the instruction of the second-class held in one of the plurality of second-entries into the second-instruction-executing-unit; and a first-control-unit to output the second-release-notification, and to change the output timing of the second-release-notification when a predetermined relationship is established between the first-timing and the second-timing, and the register is used by the subsequent instruction of the second-class.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a calculation processing device according to an embodiment;

FIG. 2 is a diagram illustrating an operation example of the calculation processing device illustrated in FIG. 1;

FIG. 3 is a diagram illustrating an example of a calculation processing device according to another embodiment;

FIG. 4 is a diagram illustrating an example of an information processing device and a calculation processing device provisioned with a core unit as illustrated in FIG. 3;

FIG. 5 is a diagram illustrating an example of an execution control unit EXCNTa as illustrated in FIG. 3;

FIG. 6 is a diagram illustrating an example of an execution control unit EXCNTe as illustrated in FIG. 3;

FIG. 7 is a diagram illustrating a circuit for holding a register number in the execution control unit EXCNTa illustrated in FIG. 3;

FIG. 8 is a diagram illustrating an operation example of the calculation processing device including the core unit illustrated in FIG. 3;

FIG. 9 is a diagram illustrating another operation example of the calculation processing device including the core unit illustrated in FIG. 3;

FIG. 10 is a diagram illustrating another operation example of the calculation processing device including the core unit illustrated in FIG. 3;

FIG. 11 is a diagram illustrating another operation example of the calculation processing device including the core unit illustrated in FIG. 3;

FIG. 12 is a diagram illustrating another operation example of the calculation processing device including the core unit illustrated in FIG. 3;

FIG. 13 is a diagram illustrating another operation example of the calculation processing device including the core unit illustrated in FIG. 3;

FIG. 14 is a diagram illustrating another operation example of the calculation processing device including the core unit illustrated in FIG. 3;

FIG. 15 is a diagram illustrating another operation example of the calculation processing device including the core unit illustrated in FIG. 3;

FIG. 16 is a diagram illustrating another operation example of the calculation processing device including the core unit illustrated in FIG. 3;

FIG. 17 is a diagram illustrating another operation example of the calculation processing device including the core unit illustrated in FIG. 3; and

FIG. 18 is a diagram illustrating another operation example of the calculation processing device including the core unit illustrated in FIG. 3.

### DESCRIPTION OF EMBODIMENTS

Hereinafter, the embodiments will be described with reference to the drawings.

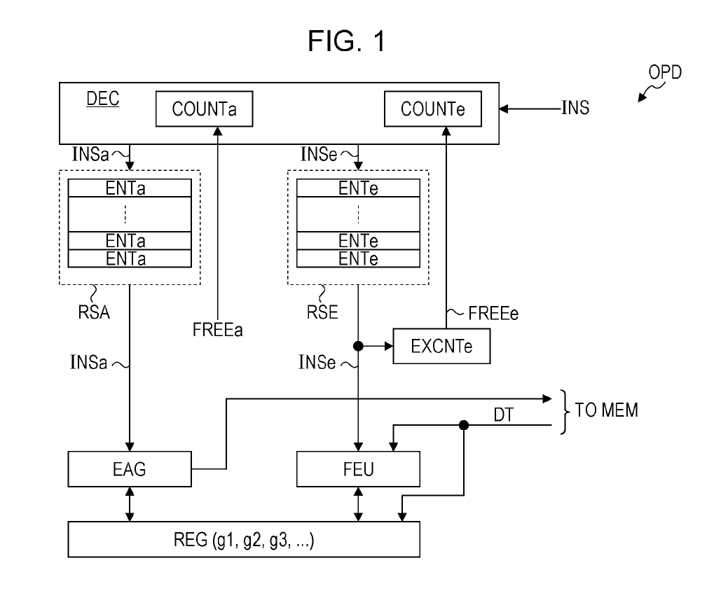

FIG. 1 is a diagram illustrating an example of a calculation processing device OPD according to an embodiment. The calculation processing device OPD is a processor such as a central processing unit (CPU), for example. The calculation processing device OPD includes a decoder unit DEC, an instruction holding unit RSA and RSE, an instruction executing unit EAG and FEU, a control unit EXCNTe, and a register unit REG.

The decoder unit DEC includes a counter COUNTa and COUNTe. The counter COUNTa increments the count value when the decoder unit DEC decodes and outputs an instruction INSa to the instruction holding unit RSA, and also decrements the count value when a release notification FREEa is input. The counter COUNTe increments the count value when the decoder unit DEC decodes and outputs an instruction INSe to the instruction holding unit RSE, and also decrements the count value when a release notification FREEe is input. The instruction INSa is, for example, a first class of instruction such as a load instruction for reading data from a memory MEM. The instruction INSe is a second class of instruction such as a calculation instruction for calculating data (i.e., add instruction, subtract instruction, shift instruction, or logical calculation instruction).

The instruction holding unit RSA includes multiple entries ENTa for holding the instruction INSa, and inputs the instruction INSa in any of the entries ENTa into the instruction executing unit EAG. The instruction holding unit RSE includes multiple entries ENTe for holding the instruction INSe, and inputs the instruction INSe in any of the entries ENTe into the instruction executing unit FEU.

The instruction executing unit EAG executes the instruction INSa, and issues an access request to a storage device MEM using data stored in the register unit REG, for example. Data DT read out from the storage device MEM is stored in the register unit REG. The storage device MEM may also be provisioned to the calculation processing device OPD, or may be a device externally connected to the calculation processing device OPD.

The instruction executing unit FEU receives the desired data for executing the instruction INSe from the register unit REG, executes the instruction INSe, and outputs the calculation result to the register unit REG. The instruction executing unit FEU also bypasses and receives the data DT stored in the register unit REG when the data DT stored in the register unit REG from the storage device MEM is used by the instruction INSa based on an antecedent instruction INSa.

The control unit EXCNTe outputs the release notification FREEe when the instruction executing unit FEU has finished executing the instruction INSe. The control unit EXCNTe changes the timing to output the release notification FREEe when both of the following two conditions are satisfied, or when at least one of the following two conditions is not satisfied.

(Condition 1) The timing when the instruction executing unit EAG finishes executing the antecedent instruction INSa input into the instruction executing unit EAG and the timing when the instruction executing unit FEU finishes executing the subsequent instruction INSe input the instruction executing unit FEU establish a predetermined relationship.
(Condition 2) The register to which the antecedent instruction INSa writes the calculation result (data DT, for example) will be used by the subsequent instruction INSe.

The register unit REG includes at least one register used by the instruction executing unit EAG and FEU (for example, g1, g2, g3, etc.). The calculation processing device OPD may also include a control unit for outputting the release notification FREEa when the instruction executing unit EAG has finished executing the instruction INSa input into the instruction executing unit EAG.

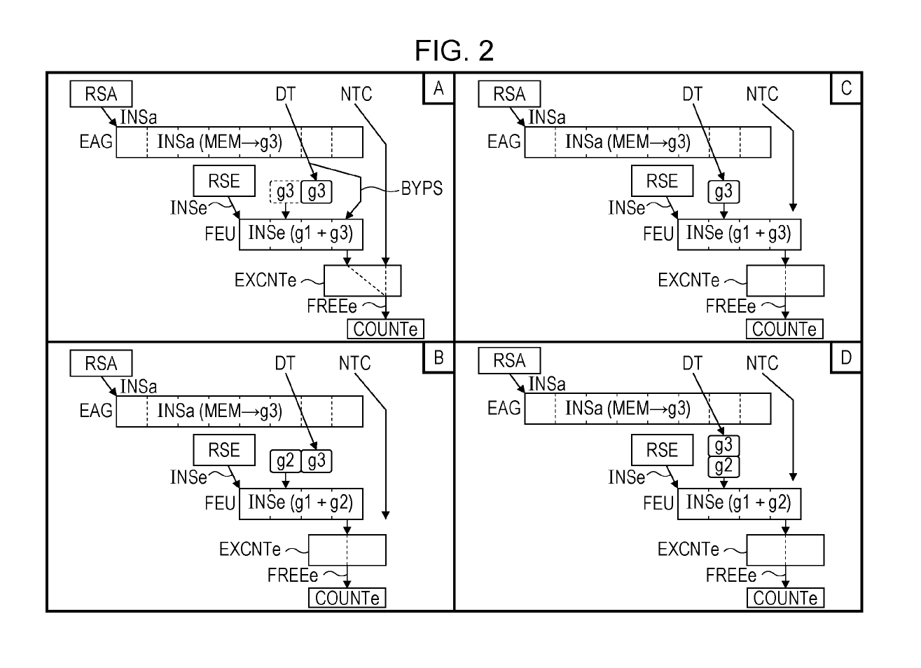

FIG. 2 is a diagram illustrating an operation example of the calculation processing device OPD illustrated in FIG. 1. The antecedent instruction INSa illustrated in operation A, operation B, operation C, and operation D is input from the instruction holding unit RSA, for example, and is a load instruction for reading the data DT from the storage device MEM to a register g3 (access instruction).

The instruction INSe illustrated in operation A and operation C is input from the instruction holding unit RSE after starting the instruction INSa, and is an add instruction to add the data stored in a register g1 and the data stored in the register g3 (calculation instruction). The instruction INSe illustrated in operation B and operation D is input from the instruction holding unit RSE after the instruction INSa starts, and is an add instruction to add the data stored in the register g1 and the data stored in a register g2.

The thick lines framing the instruction executing unit EAG and FEU illustrate the execution period of the instruction INSa and INSe. Each region marked by the dashed line inside the thick-line frame illustrate a pipeline execution cycle. That is to say, each operation A, operation B, operation C, and operation D is a timing chart where time passes from the left side to the right side of FIG. 2.

The operation A represents the situation when the subsequent instruction INSe uses the register g3, to which the data DT obtained by the execution of the antecedent instruction INSa is written, when the timings at which the execution of the instruction INSa and INSe finish establish a predetermined relationship. That is to say, operation A satisfies the aforementioned Condition 1 and Condition 2. With operation A, there is a dependent relationship between the register which the antecedent instruction INSa uses and the register which the subsequent instruction INSe uses.

When Condition 1 and Condition 2 are satisfied, the instruction executing unit FEU receives the data DT before being stored in the register g3 output from the storage device MEM, and so a calculation is executable. That is to say, the instruction executing unit FEU may execute a bypass processing BYPS for the data DT. When the bypass processing BYPS is executed, the control unit EXCNTe outputs the release notification FREEe based on a notification NTC indicating that the loading of the data DT from the storage device MEM is complete, for example.

When the storage device MEM is in an arrangement separated from the instruction executing unit FEU, for example, the instruction executing unit FEU may receive the notification NTC after the execution of the instruction INSe is complete. In this case, the timing at which the release notification FREEe is output is delayed as compared with operation B. The release notification FREEe is output at the next cycle after the execution of the instruction INSe is complete, which results in the output timing of the release notification FREEe to be one cycle later than the operation B.

The operation B represents the situation when the subsequent instruction INSe does not use the register g3 to which the data DT obtained by the execution of the antecedent instruction INSa is written when the timings at which the execution of the instruction INSa and INSe finish establish a predetermined relationship (the same cycle, for example). That is to say, the operation B satisfies the previously described Condition 1, but does not satisfy Condition 2. There is no dependent relationship between the register used by the antecedent instruction INSa and the register used by the subsequent instruction INSe for the operation B.

The operation C represents the situation when the subsequent instruction INSe uses the register g3 to which the data DT obtained by the execution of the antecedent instruction INSa is written when the timings at which the execution of the instruction INSa and INSe finish do not establish a predetermined relationship (the same cycle, for example). That is to say, the operation C does not satisfy the previously described Condition 1, but does satisfy Condition 2. There is a dependent relationship between the register used by the antecedent instruction INSa and the register used by the subsequent instruction INSe.

The operation D represents the situation when the subsequent instruction INSe does not use the register g3 to which the data DT obtained as the result of calculation by the execution of the antecedent instruction INSa is written when the timings at which the execution of the instruction INSa and INSe finish does not establish a predetermined relationship. That is to say, the operation D does not satisfy both of the previously described Condition 1 and Condition 2. There is no dependent relationship between the register used by the antecedent instruction INSa and the register used by the subsequent instruction INSe.

According the present embodiment, when either Condition 1 or Condition 2 or both are not satisfied, the bypass processing BYPS is not executed, and so the control unit EXCNTe may output the release notification FREEe at a timing when the calculation is complete, without waiting for the notification NTC. As a result, the counter COUNTe may be decremented without a dependence on the notification NTC. The entry ENTe of the instruction holding unit RSE is released according to the decrement of the counter COUNTe.

In contrast, when the present embodiment is not applied, in order for operation A to function, the control unit EXCNTe outputs the release notification FREEe based on the notification NTC in accordance with the timing that the notification NTC is received during the other operations B, C, and D. In this case, the timings at which the count value of the counter COUNTe is decremented during the operations B, C, and D are delayed in comparison with the present embodiment. As a result, the timings at which the entries ENTe in the instruction holding unit RSE are released is also delayed in comparison with the present embodiment, and the aggregate number of instructions INSe that may be held in the instruction holding unit RSE during a predetermined period is less than compared with the present embodiment.

Thus, according to the present embodiment, the control unit EXCNTe changes the output timing of the release notification FREEe when both the Condition 1 and Condition 2 are satisfied, and when either the Condition 1 or the Condition 2 or both are not satisfied. As a result, when either the Condition 1 or the Condition 2 or both are not satisfied, the release notification FREEe may be output without waiting for the notification NTC, for example, and so the timing at which the counter COUNTe is decremented is earlier than that of the related art. Therefore, the aggregate number of instructions INSe that may be held in the instruction holding unit RSE during a predetermined period may be increased as compared to the state before the application of the present embodiment. As a result, the utilization efficiency of the instruction holding unit RSE is may be improved, and the performance of the calculation processing device OPD may be improved.

Also, the bypass processing BYPS is executed during operation A as illustrated in FIG. 2, and is not executed during operations B, C, and D. The frequency that the bypass processing BYPS is executed is lower than the frequency that the bypass processing BYPS is not executed. According to the present embodiment, when the bypass processing BYPS is not executed, the output timing of the release notification FREEe may be one cycle earlier. As a result, the average value of the timings at which the counter COUNTe is decremented is earlier than that of the related art, and the average value of timings at which the instruction holding unit RSE releases the entry ENTe is earlier than that of the related art.

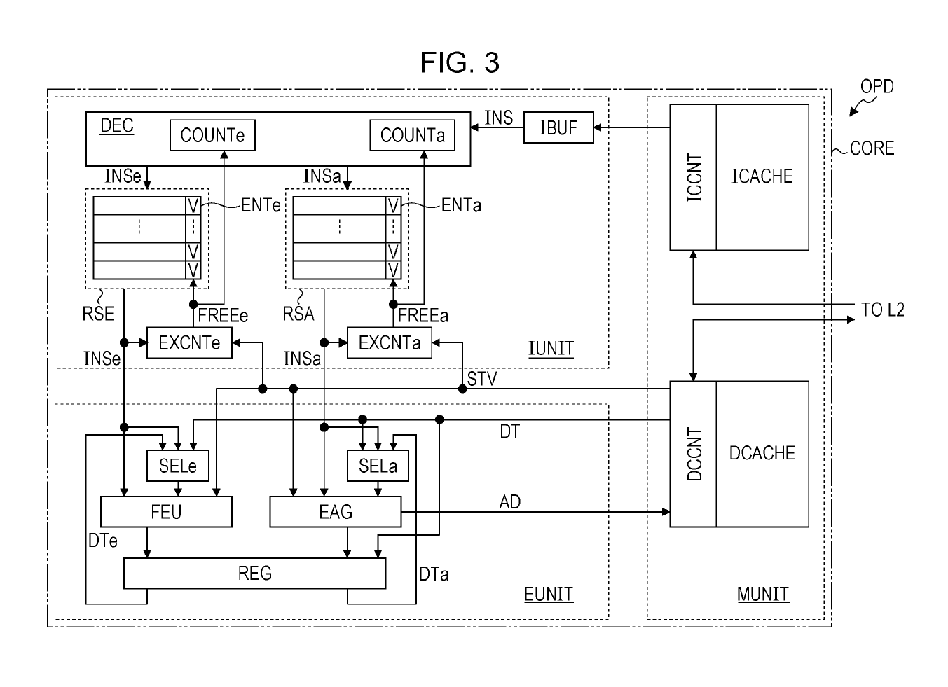

FIG. 3 is a diagram illustrating an example of the calculation processing device OPD according to another embodiment. The components that are the same as or similar to that of FIG. 1 have the same reference numerals, and so their detailed description is omitted here.

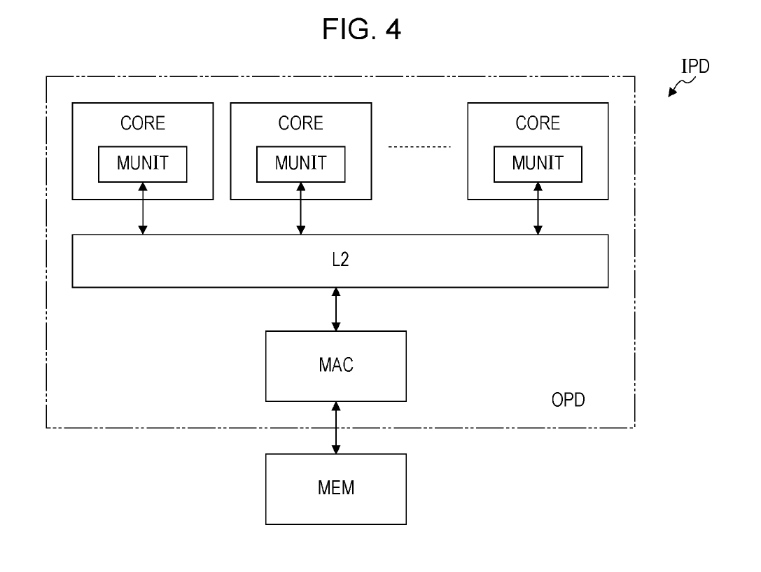

The calculation processing device OPD is a processor such as a CPU, for example. The calculation processing device OPD includes a core unit CORE such as a CPU core. An example of the calculation processing device OPD is illustrated in FIG. 4. The core unit CORE includes a storage unit MUNIT, an instruction control unit IUNIT and an executing unit EUNIT.

The storage unit MUNIT includes an instruction cache ICACHE, a data cache DCACHE, and control circuits ICCNT and DCCNT. The instruction cache ICACHE stores the program executed by the executing unit EUNIT. The data cache DCACHE stores data processed by the executing unit EUNIT. The instruction cache ICACHE and the data cache DCACHE are primary cache memory, for example.

The control circuit ICCNT reads data (program) from the instruction cache ICACHE based on an access request to the instruction cache ICACHE, and writes data (program) transferred from an external device (a secondary cache L2, for example) to the instruction cache ICACHE.

The control circuit DCCNT reads the data DT from the data cache DCACHE based on an access request to the data cache DCACHE, and writes the data DT to the data cache DCACHE. The control circuit DCCNT also writes data transferred from an external device (a secondary cache L2, for example) to the data cache DCACHE, and outputs the data stored in the data cache DCACHE to an external device of the core unit CORE.

The instruction control unit IUNIT includes an instruction buffer IBUF, a decoder unit DEC, reservation stations which are reservation station for execution (RSE) and reservation station for addresses (RSA), and an execution control unit EXCNTe and EXCNTa. The reservation stations RSE and RSA enable an out-of-order function in which instructions are executed in a sequence different from the instruction sequence written in a program. The reservation station RSA is an example of a first instruction holding unit, and the reservation station RSE is an example of a second instruction holding unit. The executing control unit EXCNTe is an example of a first control unit, and the executing control unit EXCNTa is an example of a second control unit.

The instruction buffer IBUF includes multiple regions for holding data (program) output from the instruction cache ICACHE. The instruction buffer IBUF sequentially outputs the held data to the decoder unit DEC as the instruction INS.

The decoder unit DEC decodes the instruction INS received from the instruction buffer IBUF, and outputs the decoded instruction to either the reservation station RSE or the reservation station RSA on the basis of the decoding result. For example, when the decoded instruction INS is the instruction INSa (hereinafter, also referred to as access instruction) associated with access address calculations such as load instructions and store instructions, the decoder unit DEC outputs the access instruction INSa to the reservation station RSA. The calculation instruction INSa is an example of a first class of instruction.

When the decoded instruction INS is the calculation instruction INSe (integer calculation instruction, for example), the decoder unit DEC outputs the calculation instruction INSe to the reservation station RSE. The calculation instruction INSe is an example of a second class of instruction.

The decoder unit DEC also includes a counter COUNTe corresponding to the reservation station RSE and a counter COUNTa corresponding to the reservation station RSA. The counter COUNTe represents the number of calculation instructions INSe accumulated in the reservation station RSE. The counter COUNTe increments the count value by one each time the calculation instruction INSe is input into the reservation station RSE from the decoder unit DEC, and decrements the count value by one each time the release notification FREEe is received.

The counter COUNTa represents the number of access instructions INSa accumulated in the reservation station RSA. The counter COUNTa increments the count value by one each time the access instruction INSa is input into the reservation station RSA from the decoder unit DEC, and decrements the count value by one each time the release notification FREEa is received.

The reservation station RSE includes multiple entries ENTe for holding calculation instructions INSe input from the decoder unit DEC. Each entry ENTe includes an instruction region for storing the calculation instruction INSe and a valid flag V indicating whether the calculation instruction INSe stored in the instruction region is valid or invalid. For example, the data stored in the instruction region includes information representing an instruction code and a number of the register to be used.

The reservation station RSE sets the valid flag V based on the input of the calculation instruction INSe from the decoder unit DEC, and resets the valid flag V based on the reception of the release notification FREEe. That is to say, when the release notification FREEe is input, the reservation station RSE releases the entry ENTe held in the calculation instruction INSe corresponding to the input release notification FREEe.

Further, the reservation station RSE may include an input flag in each instruction region that is set based on the input of the calculation instruction INSe to the executing unit EUNIT, and is reset after responding to a corresponding completion notification STV. The calculation instruction INSe not executed by the executing unit EUNIT due to the input flag is inhibited from being duplicated and input from the reservation station RSE.

The reservation station RSE also resets the input flag when the completion notification STV corresponding to the calculation instruction INSe input into the executing unit EUNIT is not received during a predetermined amount of time. The calculation instruction INSe not executed during a predetermined amount of time may be aborted by the executing unit EUNIT. Abortion of the calculation instruction INSe occurs, for example, when the calculation instruction INSe references the register to which data associated with a load instruction was not transferred by the storage unit MUNIT due to a cache miss or similar. The input flag enables the reservation station RSE to re-input the calculation instruction INSe into the executing unit EUNIT when a predetermined amount of time has elapsed from when the calculation instruction INSe was input into the executing unit EUNIT.

The reservation station RSA includes multiple entries ENTa for holding access instructions INSa input from the decoder unit DEC. Each entry ENTa includes an instruction region for storing the access instruction INSa and a valid flag V indicating whether the access instruction INSa stored in the instruction region is valid or invalid. For example, the data stored in the instruction region includes information representing an instruction code and a number of the register to be used.

The reservation station RSA sets the valid flag V based on the input of the calculation instruction INSa from the decoder unit DEC, and resets the valid flag V based on the reception of the release notification FREEa. That is to say, when the release notification FREEa is input, the reservation station RSA releases the entry ENTa held in the calculation instruction INSa corresponding to the input release notification FREEa.

Further, the reservation station RSA may include an input flag in each instruction region that is set based on the input of the access instruction INSa to the executing unit EUNIT, and is reset after responding to a corresponding completion notification STV. The access instruction INSa not executed by the executing unit EUNIT due to the input flag is inhibited from being duplicated and input from the reservation station RSA.

The reservation station RSA also resets the input flag when the completion notification STV corresponding to the access instruction INSa input into the executing unit EUNIT is not received during a predetermined amount of time. An access instruction INSa not executed during a predetermined amount of time may have been aborted by the executing unit EUNIT. Abortion of the access instruction INSa occurs, for example, when the data associated with a load instruction was not transferred by the storage unit MUNIT due to a cache miss or similar to a register. The input flag enables the reservation station RSA to re-input the calculation instruction INSa into the executing unit EUNIT when a predetermined amount of time has elapsed from when the calculation instruction INSa was input into the executing unit EUNIT.

Further, the instruction control unit IUNIT may include a floating point calculation instruction reservation station or a branch instruction reservation station in addition to the reservation stations RSE and RSA.

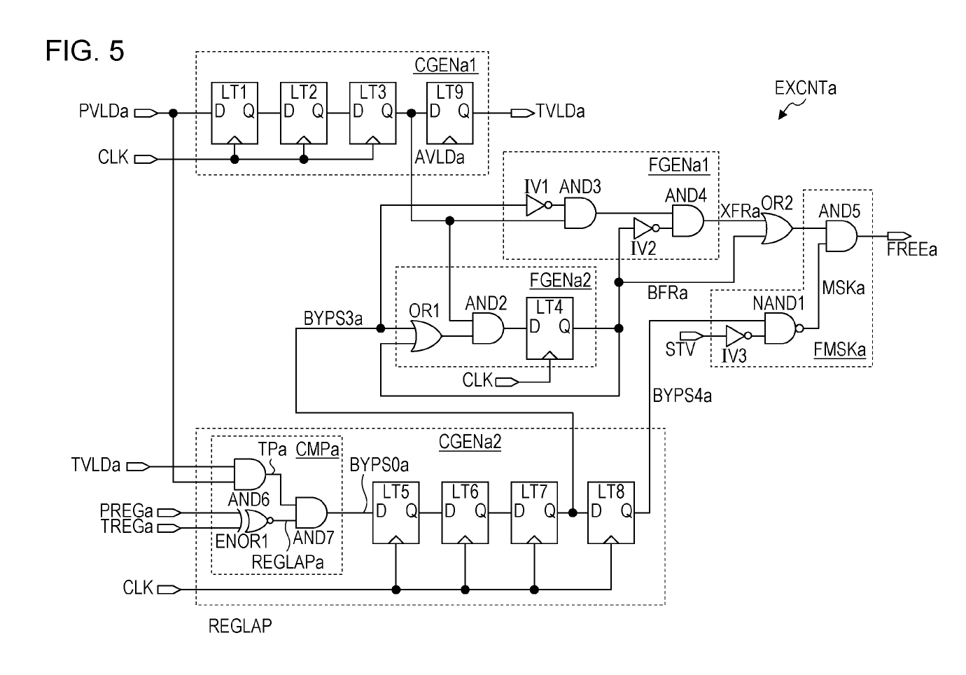

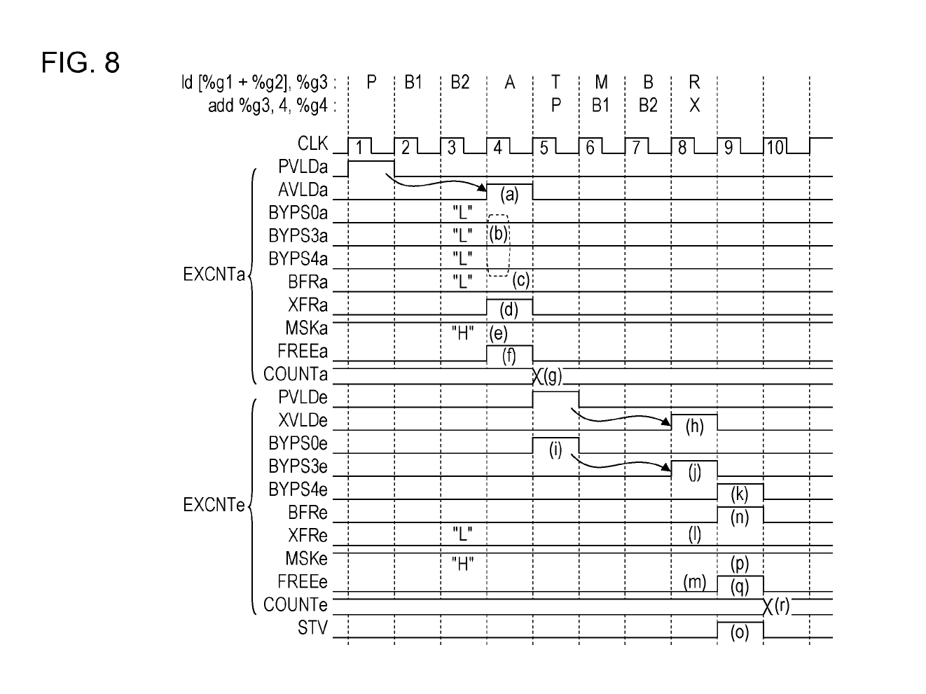

The executing control unit EXCNTe receives the completion notification STV and the calculation instruction INSe input from the reservation station RSE into the executing unit EUNIT, and outputs the release notification FREEe. The release notification FREEe includes information indicating that the execution of the calculation instruction INSe is complete, and information indicating the entry ENTe holding the calculation instruction INSe which has been executed. The output timing of the release notification FREEe changes depending on the dependent register relationship between the execution timings of the calculation instruction INSe and the access instruction INSa executed in sequence by the executing unit EUNIT. An example of the executing control unit EXCNTe is illustrated in FIG. 5. Examples of the output timing of the release notification FREEe are illustrated in FIGS. 8 through 18.

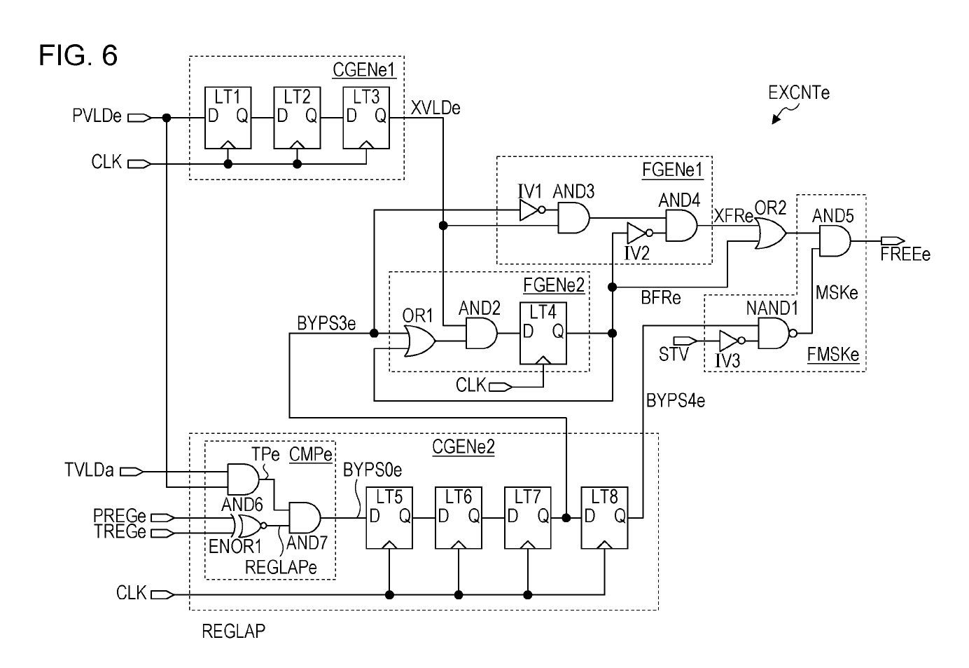

The executing control unit EXCNTa receives the completion notification STV and the access instruction INSa input from the reservation station RSA into the executing unit EUNIT, and outputs the release notification FREEa. The release notification FREEa includes information indicating that the execution of the access instruction INSa is complete, and information indicating the entry ENTa holding the access instruction INSa which has been executed. The output timing of the release notification FREEa changes depending on the dependent register relationship between the execution timings of the calculation instruction INSe and the access instruction INSa executed in sequence by the executing unit EUNIT. An example of the executing control unit EXCNTa is illustrated in FIG. 6. Examples of the output timing of the release notification FREEa are illustrated in FIGS. 8 through 18.

The executing unit EUNIT includes an address generating unit EAG, a calculating unit FEU, a register unit REG, and a selector SELe and SELa. The register unit REG includes multiple registers used by the calculation instruction INSe and the access instruction INSa (registers g1, g2, g3, etc. illustrated in FIG. 8 and others). The address generating unit EAG is an example of a first instruction executing unit for executing the first class of instructions. The calculating unit FEU is an example of a second instruction executing unit for executing the second class of instructions.

The address generating unit EAG receives data from the access instruction INSa input from the reservation station RSA and the selector SELa, and generates an access address AD indicating the access destination of the data cache DCACHE. The selector SELa outputs the data DTa from the register unit REG or immediate value from the reservation station RSE or the data DT from the data cache DCACHE to the address generating unit EAG.

The calculating unit FEU receives data from the calculation instruction INSe input from the reservation station RSE and from the selector SELe, and executes the calculation (fixed point calculation, for example). The selector SELe outputs the data DTe from the register unit REG or immediate value from the reservation station RSE or the data DT from the data cache DCACHE to each calculator in the calculating unit FEU.

The path in which the data DT is transferred from the data cache DCACHE to the selector SELa and selector SELe is used in the bypass processing described later. Further, the executing unit EUNIT may include a floating point calculating unit in addition to the calculating unit FEU.

FIG. 4 is a diagram illustrating an example of an information processing device IPD and the calculation processing device OPD provisioned with the core unit CORE illustrated in FIG. 3. The information processing device IPD includes the calculation processing device OPD and the storage device MEM. The storage device MEM is a memory module such as a dual inline memory module (DIMM) provisioned with multiple dynamic random access memory (DRAM) modules, for example.

The calculation processing device OPD includes at least one core unit CORE, a secondary cache L2, and a memory access controller MAC. The secondary cache L2 is shared by multiple core units CORE, and includes a secondary cache memory and a secondary cache memory control circuit. When the data corresponding to the access request from the core units CORE is not stored in the secondary cache (cache miss), the memory access controller MAC accesses the storage device MEM based on the access request from the secondary cache L2.

Further, the memory access controller MAC may be in an arrangement external to the calculation processing device OPD. Also, when the secondary cache L2 includes a function to control access to the storage device MEM, the storage device MEM is connected to the secondary cache L2 without going through the memory access controller MAC. In this case, the calculation processing device OPD does not wait for the memory access controller MAC.

FIG. 5 is a diagram illustrating an example of the executing control unit EXCNTa illustrated in FIG. 3. FIG. 5 illustrates a circuit to generate the release notification FREEa in the executing control unit EXCNTa. The executing control unit EXCNTa includes a cycle generator CGENa1 and CGENa2, a signal generator FGENa1 and FGENa2, and a mask circuit FMSKa.

Hereafter, each cycle (stage) of the pipeline for dividing and executing instructions into multiple stages will be described. The access instruction INSa such as a load instruction Id includes the following cycles, for example. D (Decode) cycle: the decoder unit DEC executes the decoding operation, and the decoded access instruction INSa is input into the reservation station RSA. P (Priority) cycle: the reservation station RSA inputs the access instruction INSa into the address generating unit EAG. B1 (Buffer) cycle: values used to calculate the address are read from a register. B2 (Buffer) cycle: the selector SELa supplies data to the address generating unit EAG. A (Address) cycle: the address generating unit EAG calculates the access address AD for accessing the data cache DCACHE. T (Tag) cycle: the data cache DCACHE accesses the tag using the access address AD received from the address generating unit EAG. M (Match) cycle: the data cache DCACHE determines a cache hit or cache miss based on the accessed tag. B (Buffer) cycle: the data cache DCACHE transfers the data DT to the register unit REG. R (Result) cycle: represents that the readout of the data DT from the data cache DCACHE is complete. Further, the number of clock cycles input between the D cycle and the P cycle differ depending on the operation of the reservation station RSA, and so the description of the D cycle is omitted from FIGS. 8 through 18, which are described later.

The calculation instruction INSe such as an add instruction add include the following cycles. D (Decode) cycle: the decoder unit DEC executes the decoding operation, and the decoded calculation instruction INSe is input into the reservation station RSE. P (Priority) cycle: the reservation station RSE inputs the calculation instruction INSe into the calculating unit FEU. B1 (Buffer) cycle: cycle where data used for calculating is read from a register. B2 (Buffer) cycle: the selector SELe supplies data to be calculated to the executing unit EUNIT. X (Execute) cycle: the calculating unit FEU calculates the data supplied from the selector SELe, and outputs the calculation result to the register unit REG. Further, similar to the load instruction Id, the number of clock cycles input between the D cycle and the P cycle differ depending on the operation of the reservation station RSE, and so the description of the D cycle is omitted from FIGS. 8 through 18, which are described later.

The cycle generator CGENa1 includes latch circuits LT1, LT2, LT3, and LT9 in a cascade arrangement to operate in synchronization with a clock CLK. The latch circuit LT1 receives a valid signal PVLDa representing the P cycle of the access instruction INSa. The valid signal PVLDa is generated as the executing control unit EXCNTa monitors the access instruction INSa input into the address generating unit EAG from the reservation station RSA.

The latch circuit LT3 generates a valid signal AVLDa three clock cycles after the valid signal PVLDa. The valid signal AVLDa represents the A cycle of the access instruction INSa. The latch circuit LT9 generates a valid signal TVLDa four clock cycles after the valid signal PVLDa. The valid signal TVLDa represents the T cycle of the access instruction INSa. During the T cycle, the data cache DCACHE accesses the tag using the access address AD received from the address generating unit EAG.

The cycle generator CGENa2 includes a comparator circuit CMPa, and latch circuits LT5, LT6, LT7, and LT8 that operate in synchronization with the clock CLK in a cascade arrangement with the output from the comparator circuit CMPa. The comparator circuit CMPa includes an ENOR circuit ENOR1 and an AND circuit AND6 and AND7.

The ENOR circuit ENOR1 outputs a overlap signal REGLAPa at a high level when the register numbers indicated by a register signal PREGa and TREGa match. The ENOR circuit ENOR1 outputs a overlap signal REGLAPa at a low level when the register numbers indicated by the register signal PREGa and TREGa are different.

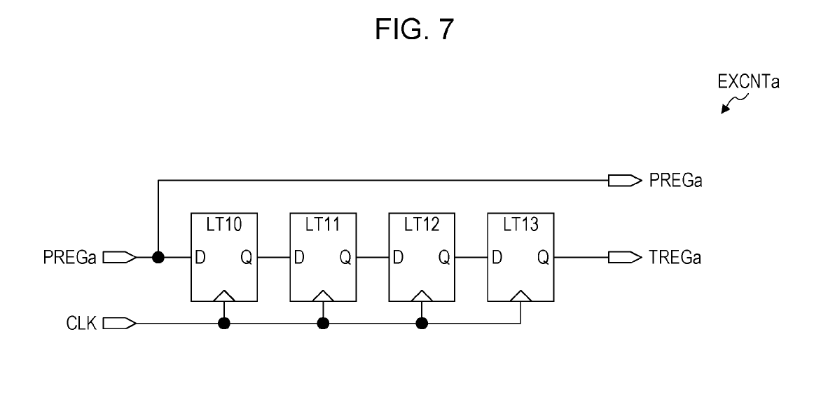

The executing control unit EXCNTa monitors the access instruction INSa input from the reservation station RSA into the address generating unit EAG in sequence, and holds the register numbers to be used by each access instruction INSa in sequence. The register number PREGa is the register number for the access instruction INSa at the P cycle. The register number TREGa is the register number for the T cycle, which is the sequentially delayed register number for the P cycle of each access instruction INSa. The circuit holding the register number until the T cycle is illustrated in FIG. 7.

Further, the register signal PREGa represents the register number of the register (source) used in the calculation of the access address AD during the A cycle of the access instruction INSa. The register number TREGa represents the register number of the register (destination) to which the data from the R cycle of the access instruction INSa is stored. That is to say the ENOR circuit ENOR1 outputs the superimposed signal REGLAPa at a high level when the register that stores the data read by the access instruction INSa and the register from which the access instruction INSa read the data (address) match.

For example, when the register signal PREGa and the register signal TREGa are both represented by a 3-bit register signal, the ENOR circuit ENOR1 compares each of the three bits, and when all bits match, the overlap signal REGLAPa is generated.

The AND circuit AND6 outputs a matching signal TPa at a high level when the valid signal PVLDa and TVLDa are both generated during the same clock cycle. The AND circuit AND6 outputs the matching signal TPa at a low level when the valid signal PVLDa and TVLDa are generated at different clock cycles. That is to say, the AND circuit AND6 outputs the matching signal TPa at a high level when the executing cycles for the antecedent T cycle of the access instruction INSa and the subsequent P cycle of the access instruction INSa are the same.

The AND circuit AND7 outputs a bypass signal BYPS0a at a high level when either the matching signal TPa or the overlap signal REGLAPa is at a high level. The AND circuit AND7 outputs the bypass signal BYPS0a at a low level when either the matching signal TPa or the overlap signal REGLAPa is at a low level.

The bypass signal BYPS0a is generated when the register storing the data DT associated with the access instruction INSa is used by a different access instruction INSa executed after the access instruction INSa, which causes the bypass processing to be executed. That is to say, the bypass signal BYPS0a is generated when the following conditions (a) and (b) are satisfied.

(a) The timing when the execution of the antecedent access instruction INSa completes and the timing when the access address is calculated by the subsequent access instruction INSa establish a predetermined relationship. (b) The register to which the calculation result from the antecedent access instruction INSa is written is used by the subsequent access instruction INSa.

For example, the bypass signal BYPS0a is output at the P cycle of the subsequent load instruction when the A cycle of the subsequent load instruction is executed during the same cycle as the R cycle of the antecedent load instruction, and the register to which data is written during the R cycle of the antecedent load instruction is used during the A cycle of the subsequent load instruction.

The latch circuits LT5, LT6, LT7, and LT8 synchronize the bypass signal BYPS0a with the clock CLK with a sequential delay. The latch circuit LT7 generates a bypass signal BYPS3a, which is the bypass signal BYPS0a with a delay of three clock cycles. The latch circuit LT8 generates a bypass signal BYPS4a, which is the bypass signal BYPS0a with a delay of four clock cycles.

The signal generator FGENa1 includes an inverter IV1 and IV2, and an AND circuit AND3 and AND4. The inverter IV1 logically inverts the bypass signal BYPS3a, and outputs this to the AND circuit AND3. The AND circuit AND3 supplies the valid signal AVLDa to the AND circuit AND4 during the period when the bypass signal BYPS3a is at a low level, and stops the supply of the valid signal AVLDa to the AND circuit AND4 during the period when the bypass signal BYPS3a is at a high level.

The inverter IV2 logically inverts the release signal BFRa, and outputs this to the AND circuit AND4. The AND circuit AND4 outputs the output of the AND circuit AND3 as a release signal XFRa during the period when the release signal BFRa is at a low level, and stops the generation of a release signal XFRe from a valid signal AVLDa during the period when the release signal BFRa is at a high level. As illustrated in FIG. 8, which will be described later, the signal generator FGENa1 is a portion of the circuit for generating the release notification FREEa during the A cycle of the access instruction INSa. The AND circuit AND3 and AND4 are circuits for reducing the generation of the release notification FREEa during the A cycle.

The signal generator FGENa2 includes an OR circuit OR1, and AND circuit AND2, and a latch circuit LT4. The OR circuit OR1 outputs the bypass signal BYPS3a or the release signal BFRa output from the latch circuit LT4. The AND circuit AND2 outputs to the latch circuit LT4 the release signal BFRa at a high level or the bypass signal BYPS3a at a high level received via the OR circuit OR1 during the period when the valid signal AVLDa is at a high level.

The latch circuit LT4 synchronizes with the clock CLK and outputs a high level signal when receiving a high level signal during a data input D, and synchronizes with the clock CLK and outputs a low level signal when receiving a high level signal during a data input D.

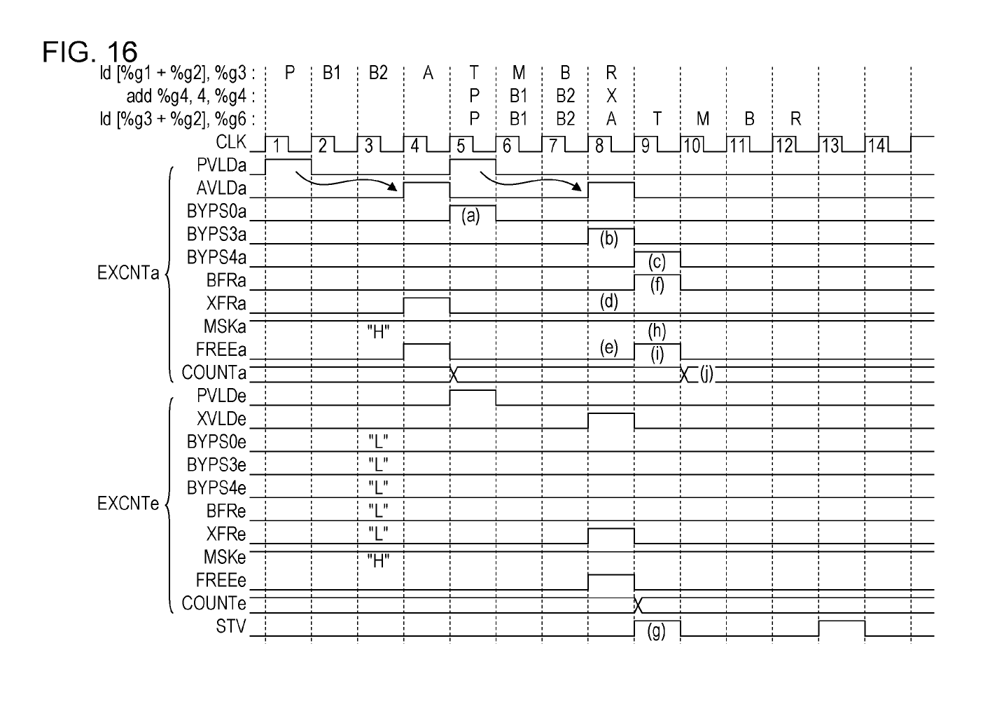

The latch circuit LT4 delays by one clock cycle the release signal BFRa or the bypass signal BYPS3a received via the OR circuit OR1 and the AND circuit AND2 during the period when the valid signal AVLDa is at a high level, and outputs this as the release signal BFRa. The supply of the bypass signal BYPS3a or the release signal BFRa to the latch circuit LT4 during the period when the valid signal AVLDa is at a low level is stopped by the AND circuit AND2, and generation of the release signal BFRa is stopped. As illustrated in FIG. 16, which will be described later, the signal generator FGENa2 is a portion of the circuit for generating the release notification FREEa during the cycle after the A cycle of the access instruction INSa.

The mask circuit FMSKa includes an inverter IV3, a NAND circuit NAND1, and an AND circuit AND5. The inverter IV3 logically inverts the completion notification STV, and outputs this to the NAND circuit NAND1. The NAND circuit NAND1 outputs a high level signal during the period when the completion notification STV is at a high level or a bypass signal BYPS4a is at a high level. The NAND circuit NAND1 also outputs a low level signal during the period when the completion notification STV is at a low level and the bypass signal BYPS4a is at a high level. That is to say, the mask circuit FMSKa stops the output of the release notification FREEa and suspends the execution of the access instruction INSa when the bypass signal BYPS4a is generated during the cycle after the A cycle of the access instruction INSa and the completion notification STV is not generated.

The AND circuit AND5 outputs, as the release notification FREEa, the release signal BFRa or the release signal XFRa received via the OR circuit OR2 during the period when the NAND circuit NAND1 outputs a high level signal. Also, the AND circuit AND5 stops the output of the release notification FREEa based on the release signal BFRa or the release signal XFRa received via the OR circuit OR2 during the period when the NAND circuit NAND1 outputs a low level signal.

Further, as previously described, the release notification FREEa includes information indicating that the execution of the access instruction INSa is complete, and information indicating the entry ENTa holding the access instruction INSa of which execution is complete. The release notification FREEa output by the mask circuit FMSKa is the release notification FREEa indicating that the execution of the access instruction INSa is complete. The information within the release notification FREEa indicating the entry ENTa holding the access instruction INSa of which execution is complete is monitored by the executing control unit EXCNTa, and is output along with the release notification FREEa using the access instruction INSa being held.

FIG. 6 is a diagram illustrating an example of the executing control unit EXCNTe illustrated in FIG. 3. Elements that are the same as or similar to those of the executing control unit EXCNTa illustrated in FIG. 5 are not described in detail. FIG. 6 illustrates a generator circuit for the release notification FREEe in the executing control unit EXCNTe. The executing control unit EXCNTe includes a cycle generator CGENe1 and CGENe2, a signal generator FGENe1 and FGENe2, and the mask circuit FMSKe.

The cycle generator CGENe2, the signal generator FGENe1 and FGENe2, and the mask circuit FMSKe are the same as or similar to the cycle generator CGENe2, the signal generator FGENe1 and FGENe2, and the mask circuit FMSK illustrated in FIG. 5.

The cycle generator CGENe1 does not have the latch circuit LT9 as in the cycle generator CGENa1 illustrated in FIG. 5. The latch circuit LT3 of the cycle generator CGENe1 generates a valid signal XVLDe, which is a valid signal PVLDe received by the latch circuit LT1 delayed by three clock cycles. The valid signal PVLDe represents the P cycle of the calculation instruction INSe. The valid signal XVLDe represents the X cycle of the calculation instruction INSe.

The ENOR circuit ENOR1 in the cycle generator CGENe2 outputs a overlap signal REGLAPe at a high level when the register numbers represented by a register signal PREGe and TREGa match. The ENOR circuit ENOR1 outputs the overlap REGLAPe at a low level when the register numbers represented by a register signal PREGe and TREGa are different. The register signal TREGa is outputs by the latch circuit LT9 of the executing control unit EXCNTa illustrated in FIG. 5.

The executing control unit EXCNTe monitors the calculation instruction INSe sequentially input into the calculating unit FEU from the reservation station RSE, and generates the register signal PREGe representing the register number used by each calculation instruction INSe. The register signal PREGe is the number of the register for the P cycle of each calculation instruction INSe.

Further, the register signal PREGe represents the number of the register from which the data is read that is used in the calculation during the B1 cycle of the calculation instruction INSe. That is to say, the ENOR circuit ENOR1 of the cycle generator CGENe2 outputs the overlap signal REGLAPe at a high level when the register for storing the data read by the access instruction INSa and the register from the data is ready by the calculation instruction INSe match.

For example, when the register signal PREGe and TREGa are both represented by a 3-bit register number, the ENOR circuit ENOR1 compares each of the three bits, and when all bits match, the overlap signal REGLAPe is generated.

There are also cases when data used in the calculation by the calculation instruction INSe is stored in multiple registers. For this reason, a comparator circuit CMPe includes multiple ENOR circuits ENOR1 for comparing multiple register signals PREGe representing register numbers of multiple registers used by the calculation instruction INSe (PREGe0 and PREGe1, for example) and the register signal TREGa. Also, the overlap signal REGLAPe is generated when one of the ENOR circuits ENOR1 outputs a high level signal.

The AND circuit AND6 outputs a matching signal TPe at a high level when the valid signal PVLDe and valid signal TVLDa are generated in the same clock cycle. The AND circuit AND6 outputs the matching signal TPe at a low level when the valid signal PVLDe and TVLDa are generated in different cycles. The valid signal TVLDa represents the T cycle of the access instruction INSa, and is generated by the executing control unit EXCNTa illustrated in FIG. 5. That is to say, the AND circuit AND6 outputs the matching signal TPe at a high level when the T cycle of the access instruction INSa and the execution cycle of the P cycle of the calculation instruction INSe are the same.

The AND circuit AND7 outputs the bypass signal BYPS0e at a high level when the matching signal TPe and the overlap signal REGLAPe are both at a high level. The AND circuit AND7 outputs the bypass signal BYPS0e at a low level when the matching signal TPe and the overlap signal REGLAPe are both at a low level.

The bypass signal BYPS0e is generated when the register storing the data DT associated with the access instruction INSa is used by a calculation instruction INSe executed after the access instruction INSa, which causes the bypass processing to be executed. That is to say, the bypass signal BYPS0e is generated when the following conditions (c) and (d) are satisfied.

(c) The timing when the execution of the antecedent access instruction INSa completes and the timing when the execution of the subsequent calculation instruction INSe completes establish a predetermined relationship. (d) The register to which the calculation result from the antecedent access instruction INSa is written is used by the subsequent calculation instruction INSe.

For example, the bypass signal BYPS0e is output at the T cycle of the antecedent load instruction when the X cycle of the subsequent calculation instruction INSe is executed during the same cycle as the R cycle of the antecedent load instruction, and the register to which data is written during the R cycle of the antecedent load instruction is used during the X cycle of the subsequent calculation instruction.

The latch circuit LT7 generates a bypass signal BYPS3e, which is the bypass signal BYPS0e with a delay of three clock cycles. The latch circuit LT8 generates a bypass signal BYPS4e, which is the bypass signal BYPS3e with a delay of one clock cycle.

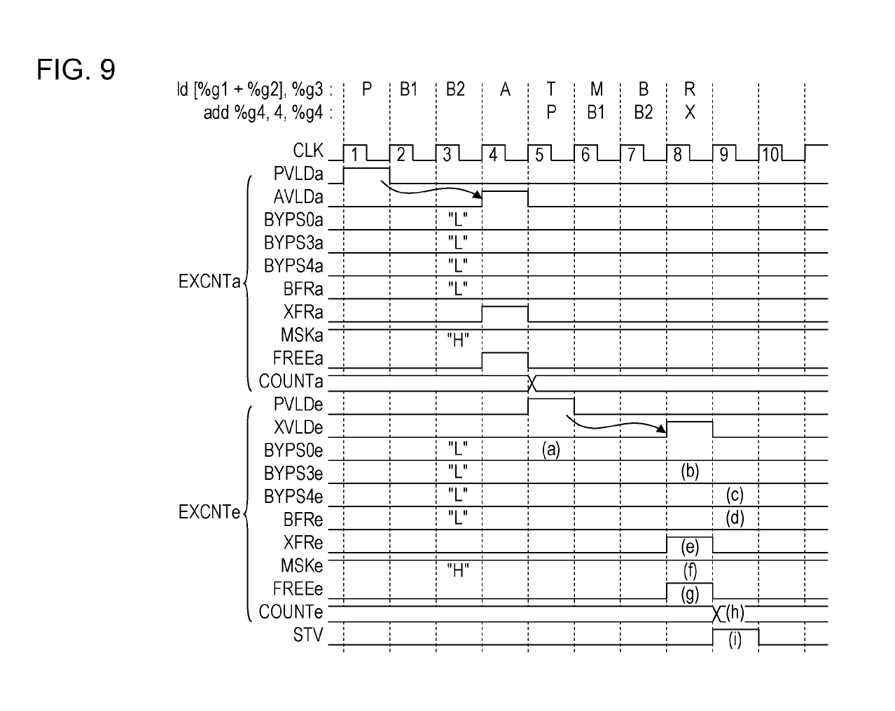

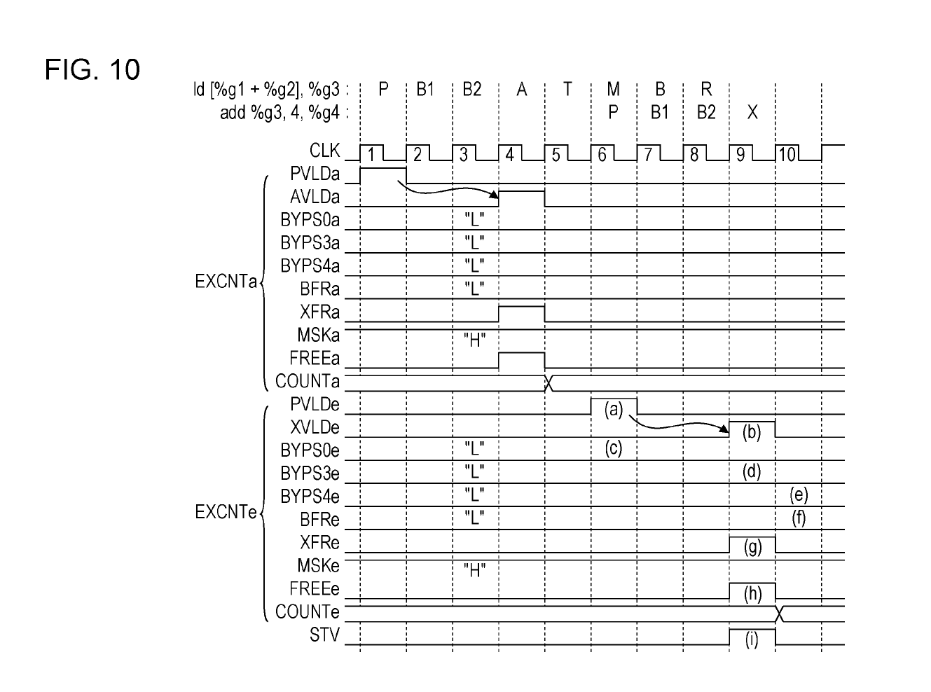

The signal generator FGENe1 outputs the valid signal XVLDe as the release signal XFRe during the period when a release signal BFRe is at a low level and the bypass signal BYPS3e is at a low level. The signal generator FGENe1 stops the generation of the release signal XFRe from the valid signal XVLDe during the period when the release signal BFRe is at a high level and the bypass signal BYPS3e is at a high level. As illustrated in FIGS. 9 and 10, which will be described later, the signal generator FGENe1 is a portion of the circuit for generating the release notification FREEe during the X cycle of the calculation instruction INSe. The AND circuit AND3 and AND4 are circuits for stopping the generation of the release notification FREEe during the X cycle.

The latch circuit LT4 delays by one cycle the release signal BFRe or the bypass signal BYPS3e are at a high level, and the signal generator FGENe2 outputs this as the release signal BFRe during the period when the valid signal XVLDe is at a high level. The generation of the release signal BFRe from the release signal BFRe of the bypass signal BYPS3e is stopped during the period when the valid signal XVLDe is at a low level. As illustrated in FIG. 8, which will be described later, the signal generator FGENe2 is a portion of the circuit for generating the release notification FREEe during the cycle after the X cycle of the calculation instruction INSe.

The mask circuit FMSKe outputs, as the release notification FREEe, the release signal XFRe or the release signal BFRe received via the OR circuit OR2 during the period when the completion notification STV is at a high level or the bypass signal BYPS4e is at a low level. Also, the mask circuit FMSKe stops the output of the release notification FREEe based on the release signal XFRe or the release signal BFRe received during the period when the completion notification STV is at a low level or the bypass signal BYPS4e is at a high level. That is to say, the mask circuit FMSKe stops the output of the release notification FREEa and suspends the execution of the calculation instruction INSe when the bypass signal BYPS4e is generated during the cycle after the X cycle of the calculation instruction INSe and the completion notification STV is not generated.

Further, as previously described, the release notification FREEe includes information indicating that the execution of the access instruction INSa is complete, and information indicating the entry ENTe holding the access instruction INSa of which execution is complete. The release notification FREEe output by the mask circuit FMSKe is the release notification FREEe indicating that the execution of the calculation instruction INSe is complete. The information within the release notification FREEe indicating the entry ENTe holding the calculation instruction INSe of which execution is complete is monitored by the executing control unit EXCNTe, and is output along with the release notification FREEe using the calculation instruction INSe being held.

FIG. 7 is a diagram illustrating a circuit for holding the number of the register in the executing control unit EXCNTa illustrated in FIG. 3. The executing control unit EXCNTa includes latch circuits LT10, LT11, LT12, and LT13 that operate in synchronization with the clock CLK in a cascade arrangement. The latch circuit LT10 receives the register signal PREGa representing the number of the register included in the access instruction INSa input into the address generating unit EAG from the reservation station RSA. The latch circuit LT13 generates the register signal TREGa, which is the register signal PREGa delayed by four clock cycles. The register signal PREGa is generated in the P cycle of each access instruction INSa, and the register number TREGa is generated in the T cycle of each access instruction INSa.

FIG. 8 is a diagram illustrating an example operation of the calculation processing device OPD including the core unit CORE illustrated in FIG. 3. That is to say, FIG. 8 illustrates a method for controlling the calculation processing device OPD. According to this example, the reservation station RSA inputs the load instruction Id, which is one type of access instruction INSa, into the address generating unit EAG. The reservation station RSE inputs the add instruction add, which is a type of calculation instruction INSe, into the calculating unit FEU. Also, the executing unit EUNIT sequentially executes the load instruction Id and the add instruction add as represented by instructions (1) and (2).

Id[% g1+% g2],% g3 (1)

add % g3,4,% g4 (2)

The instruction (1) for the load instruction Id represents the adding of the value stored in the register g1 and the value stored in the register g2, reading the data from the access address represented by the sum value, and storing this data into the register g3. The instruction (2) for the add instruction add represents the adding of an immediate value four to the data stored in the register g3, and storing the addition result into the register g4. For example, registers g1, g2, g3, and g4 are general purpose registers provisioned within the register unit REG illustrated in FIG. 3.

According to the instructions (1) and (2), the add instruction add executes a calculation using the data read from the register g3 produced by the load instruction Id. That is to say, the instructions (1) and (2) have a dependent relationship between the registers. Also, the T cycle of the load instruction Id and the execution cycle of the P cycle of the add instruction add are the same. For this reason, the bypass processing is executed at the eighth clock cycle.

During the B1 cycle of the access instruction INSa, data is read from registers g1 and g2 into the selector SELa. During the B2 cycle of the access instruction INSa, the selector SELa selects the path from the registers g1 and g2, and the data read from the registers g1 and g2 is supplied to the address generating unit EAG.

During the A cycle of the access instruction INSa, the address generating unit EAG adds the data read from the registers g1 and g2 to obtain the access address AD. During the M cycle of the access instruction INSa, when a cache hit is determined, the data cache DCACHE outputs the read data DT to the executing unit EUNIT. During the B cycle of the access instruction INSa, the data DT output from the data cache DCACHE is stored in the register g3.

In contrast, during the B1 cycle of the calculation instruction INSe, the data is read from the register g3 into the selector SELe. According to this example, as the bypass processing is executed, the data output from the data cache DCACHE to the register g3 during the B cycle is also supplied to the selector SELe via a bypass path connecting the data cache DCACHE and the selector SELe.

During the B2 cycle of the calculation instruction INSe, the selector SELe selects an immediate value four output from the bypass path and the reservation station RSE, and supplies this to the calculating unit FEU. During the X cycle of the calculation instruction INSe, the calculating unit FEU adds an immediate value four to the data in register g3 obtained by the bypass processing, and stores the addition result in the register g4.

The cycle generator CGENa1 in the executing control unit EXCNTa illustrated in FIG. 6 receives the valid signal PVLDa generated during the P cycle of the load instruction Id, and generates the valid signal AVLDa for the A cycle ((a) of FIG. 8). The P cycle of the load instruction Id does not overlap with the T cycle of another access instruction INSa. For this reason, the cycle generator CGENa2 maintains the bypass signal BYPS0a, BYPS3a, and BYPS4a at a low level ((b) of FIG. 8).

The signal generator FGENa2 receives the bypass signal BYPS3a at a low level, and maintains the release signal BFRa at a low level ((c) of FIG. 8). The signal generator FGENa1 receives the release signal BFRa at a low level, enables the AND circuit AND3 and AND4, and outputs the valid signal AVLDa as the release signal XFRa ((d) of FIG. 8).

The NAND circuit NAND1 of the mask circuit FMSKa receives the bypass signal BYPS4a at a low level, and maintains a mask signal MSKa at a high level ((e) of FIG. 8). The AND circuit AND5 of the mask circuit FMSKa receives the mask signal MSKa at a high level, becomes enables, and outputs the release signal XFRa as the release notification FREEa ((f) of FIG. 8).

The reservation station RSA receives the release notification FREEa, and releases one entry ENTa by resetting the valid flag V of the entry ENTa holding the load instruction Id currently executing. As a result, the number of access instructions INSa held in the reservation station RSA is decreased by one. The counter COUNTa in the decoder unit DEC receives the release notification FREEa and decrements the count value ((g) of FIG. 8). The entry ENTa in the reservation station RSA is released in this way on the basis of the A cycle for calculating the access address of the data cache DCACHE.

In contrast, the cycle generator CGENe1 in the executing control unit EXCNTe illustrated in FIG. 5 receives the valid signal PVLDe generated during the P cycle of the add instruction add, and generates the valid signal AVLDe during the X cycle ((h) of FIG. 8). The P cycle of the add instruction add overlaps with the T cycle of the load instruction Id, and the use of the register g3 also overlaps. For this reason, the cycle generator CGENe2 generates the bypass signal BYPS0e, BYPS3d, and BYPS4e at the fifth, eight, and ninth clock cycles, respectively ((i, j, and k) of FIG. 8).

The signal generator FGENe1 receives the bypass signal BYPS3e at a high level, and the AND circuit AND3 stops the transfer of the valid signal XVLDe. As a result, the release signal XFRe is not generated during the X cycle of the add instruction add, and so the release notification FREEe is not generated (l and m) of FIG. 8).

The signal generator FGENe2 generates the release signal BFRe at the ninth clock cycle based on the bypass signal BYPS3e at a high level and the valid signal XVLDe at a high level generated at the eighth clock cycle ((n) of FIG. 8). The release signal BFRe is supplied to the AND circuit AND5 of the mask circuit FMSKe.

The NAND circuit NAND1 in the mask circuit FMSKe receives the bypass signal BYPS4e at a high level at the ninth clock cycle, and also receives the inverted signal of the completion notification STV at a high level at the ninth clock cycle ((o) of FIG. 8). The NAND circuit NAND1 maintains the mask signal MSKe at a high level, and enables the AND circuit AND5 on the basis of the completion notification STV at a high level ((p) of FIG. 8). The AND circuit AND5 outputs the release signal BFRe at a high level as the release notification FREEe based on the mask signal MSKe at a high level ((q) of FIG. 8).

The reservation station RSE receives the release notification FREEe, and release one entry ENTe by resetting the valid flag V of the entry ENT holding the add instruction add that has finished executing. As a result, the number of calculation instructions INSe held in the reservation station RSE decreases by one. The counter COUNTe of the decoder unit DEC receives the release notification FREEe and decrements the count value ((r) of FIG. 8).

The completion notification STV is output from the control circuit DCCNT in the storage unit MUNIT during the R cycle of the load instruction Id, for example. However, according to the present embodiment, the executing control unit EXCNTe and EXCNTa receive the completion notification STV at the next clock cycle after being output due to the load on the signal wiring for transferring the completion notification STV.

FIG. 9 is a diagram illustrating another operation example of the calculation processing device OPD including the core unit CORE illustrated in FIG. 3. That is to say, FIG. 9 illustrates a method for controlling the calculation processing device OPD. The operations that are the same as or similar to that in FIG. 8 are not described in detail.

According to this example and similar to that in FIG. 8, the load instruction Id and the add instruction add are input into the executing unit EUNIT. Also, the executing unit EUNIT sequentially executes the load instruction Id and the add instruction add as represented by instructions (3) and (4).

Id[% g1+% g2],% g3 (3)

add % g4,4,% g4 (4)

According to the instructions (3) and (4), the register used by the load instruction Id and the register used by the add instruction add are different, and the instructions (3) and (4) do not have a dependent relationship between the registers. The T cycle of the load instruction Id and the P cycle of the add instruction add are executed at the same clock cycle, but as there is no dependent relationship between the registers, the bypass processing is not executed.

In FIG. 9, the operations up to the fourth clock cycle are the same as or similar to those in FIG. 8. According to this example, the comparator circuit CMPe illustrated in FIG. 6 does not generate the bypass signal BYPS0e at the fifth clock cycle, as the load instruction Id and the add instruction add does not have a dependent relationship between the registers ((a) of FIG. 9). As a result, the bypass signal BYPS3e and BYPS4e, and the release signal BFRe are not generated at the eighth and ninth clock cycles ((b, c, and d) of FIG. 9). The signal generator FGENe1 receives the bypass signal BYPS3e at a low level and the release signal BFRe at a low level, enables the AND circuit AND3 and AND4, and generates the release signal XFRe based on the valid signal XVLDe ((e) of FIG. 9). The mask circuit MSKe receives the bypass signal BYPS4e at a low level, and maintains the mask signal MSKe at a high level regardless of the logical value of the completion notification STV ((f) of FIG. 9). Also, the mask circuit FMSKe enables the AND circuit AND5 by the mask signal MSKe at a high level, and generates the release notification FREEe based on the release signal XFRe ((g) of FIG. 9).

Similar to that in FIG. 8, the reservation station RSE receives the release notification FREEe, resets the valid flag V, and releases one entry ENTe. The counter COUNTe of the decoder unit DEC receives the release notification FREEe and decrements the count value ((h) of FIG. 9). The control circuit DCCNT in the storage unit MUNIT illustrated in FIG. 3 outputs the completion notification STV during the R cycle of the load instruction Id ((i) of FIG. 9).

When there is no dependent relationship between the registers, the release notification FREEe is output one clock cycle earlier than when there is a dependent relationship between the registers (FIG. 8). As a result, the counter COUNTe may decrement the count value one clock cycle earlier than that in FIG. 8. The reservation station RSE may release the entry ENTe one clock cycle earlier than that in FIG. 8. Therefore, the decoder unit DEC may input more calculation instructions INSe into the reservation station RSE than that in FIG. 8.

For example, when the calculation instruction INSe is stored in all entries ENTe in the reservation station RSE, the decoder unit DEC stops the input of new calculation instructions INSe into the reservation station RSE. In this case, by executing the operations illustrated in FIG. 9, the entries ENT are released earlier than that in FIG. 8. As a result, the utilization efficiency of the reservation station RSE may be improved, and so the performance of the calculation processing device OPD may be improved.

FIG. 10 is a diagram illustrating another operation example of the calculation processing device OPD including the core unit CORE as illustrated in FIG. 3. That is to say, FIG. 10 illustrates a method for controlling the calculation processing device OPD. The operations that are the same as or similar to that in FIGS. 8 and 9 are not described in detail.

According to this example, the executing unit EUNIT sequentially executes the same instructions (1) and (2) as in FIG. 8, that is to say, the load instruction Id and the add instruction add. The register g3 used by the load instruction Id is the same register g3 used by the add instruction add, and so the load instruction Id and the add instruction add have a dependent relationship between the registers. However, the P cycle of the add instruction add is executed at a clock cycle different from the T cycle of the load instruction Id, and so the bypass processing is not executed.

In FIG. 10, the operation of the executing control unit EXCNTa is the same as or similar to that in FIG. 9. According to this example, the P cycle of the add instruction add is executed at the sixth clock cycle. For this reason, the valid signal PVLDe is generated at the sixth clock cycle, and the valid signal XVLDa is generated at the ninth clock cycle ((a and b) of FIG. 10).

The valid signal TVLDa and the valid signal PVLDe are generated at different clock cycles, and so the AND circuit AND6 in comparator circuit CMPe illustrated in FIG. 6 maintains the match signal TPe at a low level. As a result, similar that in FIG. 9, the bypass signals BYPS0e, BYPS3e, and BYPS4e, and the release signal BFRe are not generated ((c, d, e, and f) of FIG. 10). Therefore, the release signal XFRe and FREEe are output at the ninth clock cycle, which is when the valid signal XVLDe is generated ((g and h) of FIG. 10). The timing that the executing control unit EXCNTa and EXECNTe, and the executing unit EUNIT receive the completion notification STV is the same as that in FIG. 8 ((i) of FIG. 10).

When the T cycle of the access instruction INSa and the P cycle of the calculation instruction INSe are executed at different clock cycles, the release notification FREEe is output at the X cycle of the calculation instruction INSe similar to that in FIG. 9. In contrast, the release notification FREEe is output at the next clock cycle after the X cycle of the calculation instruction INSe according to that in FIG. 8. Therefore, the counter COUNTe may decrement the count value for the calculation instruction INSe one clock cycle earlier than that in FIG. 8. The reservation station RSE may release the entry ENTe one clock cycle earlier than that in FIG. 8. Therefore, the decoder unit DEC may input more calculation instructions INSe into the reservation station RSE than that in FIG. 8. As a result, similar to that in FIG. 9, the utilization efficiency of the reservation station RSE may be improved, and so the performance of the calculation processing device OPD may be improved.

The calculation processing device OPD executes the same operations as that in FIG. 10 when the T cycle of the access instruction INSa and the P cycle of the calculation instruction INSe are executed at different clock cycles, and when there is no dependent relationship between the registers.

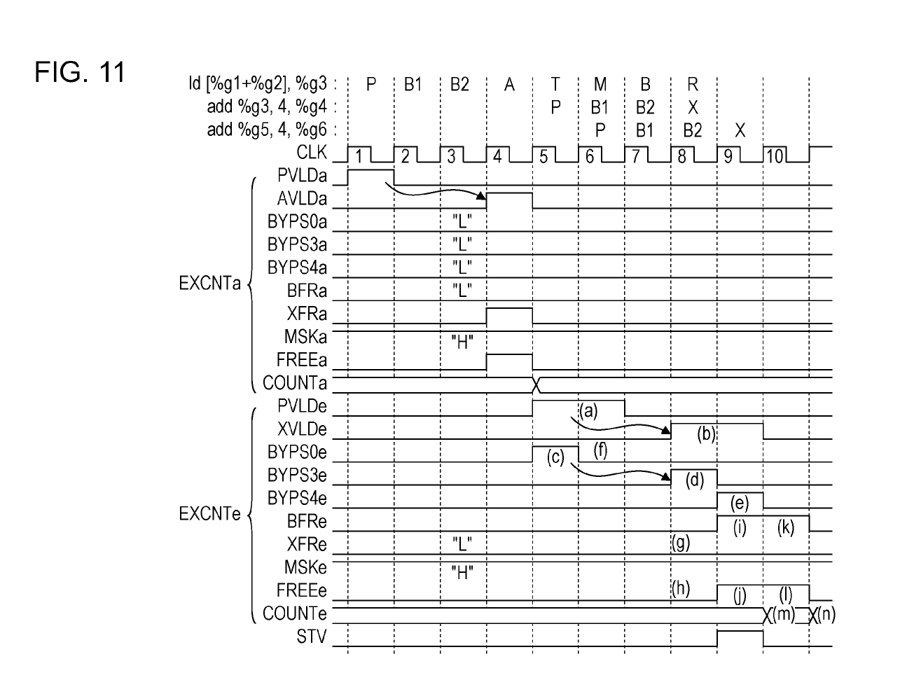

FIG. 11 is a diagram illustrating another operation example of the calculation processing device OPD including the core unit CORE illustrated in FIG. 3. That is to say, FIG. 11 illustrates a method for controlling the calculation processing device OPD. The operations that are the same as or similar to that in FIG. 8 are not described in detail.

According to the present example, the reservation station RSA inputs the load instruction Id, which is a type of access instruction INSa, into the address generating unit EAG. The reservation station RSE sequentially inputs two add instructions add, which are a type of calculation instruction INSe, into the calculating unit FEU. The executing unit EUNIT sequentially executes the load instruction Id and the two add instructions add as represented by instructions (5), (6), and (7).

Id[% g1+% g2],% g3 (5)

add % g3,4,% g4 (6)

add % g5,4,% g6 (7)

The instructions (5) and (6) are the same as the previously described instructions (1) and (2). The instruction (7) for the add instruction add represents the adding of an immediate value 4 to the data stored in the register g5, and storing the calculation result in the register g6. For example, registers g1 through g6 are general purpose registers provisioned in the register unit REG illustrated in FIG. 3.

According to the instructions (5) and (6), similar to the instructions (1) and (2), the execution cycle of the T cycle of the load instruction Id and the P cycle of the add instruction add are the same, and as the register g3 is used by both instructions, the bypass processing is executed. According to the instructions (5) and (7), the execution cycle of the T cycle of the load instruction Id and the P cycle of the add instruction add are different, and as the registers used are also different, the bypass processing is not executed. That is to say, instructions (5) and (6) have a dependent relationship between the registers used, and the instructions (5) and (7) do not have a dependent relationship between the registers used.

In FIG. 11, the operation of the executing control unit EXCNTa is the same as or similar to that in FIG. 9. The executing control unit EXCNTe generates the valid signal PVLDe representing the P cycle of the second add instruction add at the sixth clock cycle ((a) of FIG. 11). In FIG. 11, the valid signal PVLDe is set at a high level during the fifth and sixth clock cycles as the P cycles of the two add instructions add are executed consecutively.

The cycle generator CGENe1 of the executing control unit EXCNTe receives the valid signal PVLDe, and generates the valid signal AVLDe in the eighth and ninth clock cycles ((b) of FIG. 11). The first add instruction add has a dependent relationship with the load instruction Id, and so the cycle generator CGENe2 sequentially generates the bypass signal BYPS0e, BYPS3e, and BYPS4e similar to that in FIG. 8 ((c, d, and e) of FIG. 11).

In contrast, as the second add instruction add does not have a dependent relationship with the load instruction Id, the bypass signal BYPS0e is not generated at the sixth clock cycle ((f) of FIG. 11). Similar to that in FIG. 8, the signal generator FGENe1 receives the bypass signal BYPS3a at a high level at the eighth clock cycle, and stops the transfer of the valid signal XVLDe. For this reason, the release signal XFRe and the release notification FREEe are not generated at the X cycle of the first add instruction add ((g and h) of FIG. 11).

Also similar to that in FIG. 8, the signal generator FGENe2 generates the release signal BFRe at the ninth clock cycle, and the mask circuit FMSKe outputs the release signal BFRe as the release notification FREEe ((i and j) of FIG. 11). Further, the signal generator FGENe2 receives the valid signal XVLDe at a high level and the release signal BFRe at a high level at the ninth clock cycle, and maintains the release signal BFRe at a high level during the tenth clock cycle ((k) of FIG. 11). The mask circuit FMSKe enables the AND circuit AND5, and outputs the release signal BFRe as the release notification FREEe on the basis of the bypass signal BYPS4e at a low level ((l) of FIG. 11).

The reservation station RSE receives the release notification FREEe at the ninth and tenth clock cycles, sequentially resets the valid flag V of the entries ENTe holding the two add instructions add that finished executing, and releases the entries ENTe. As a result, the number of the calculation instructions INSe held in the reservation station RSE is decreased by one. The counter COUNT of the decoder unit DEC receives the release notification FREEe and executes the operation to decrement the count value two times ((m and n) of FIG. 11).

When the bypass processing is executed by the antecedent calculation instruction INSe from among two consecutive calculation instructions INSe (add instructions add for this example), the release notification FREEe corresponding to the antecedent calculation instruction INSe is output at the clock cycle after the X cycle. In contrast, as the bypass processing is not executed for the subsequent calculation instruction INSe, the release notification FREEe corresponding to the subsequent calculation instruction INSe would be output at the X cycle of the subsequent calculation instruction INSe, if using the same operation as in FIG. 9.

In this case, the release notifications FREEe for the antecedent calculation instruction INSe and the subsequent calculation instruction INSe overlap, and the decrement operation of the counter COUNTe and the release control of entry ENTe of the reservation station RSE becomes complex.

According to the present embodiment, as illustrated in FIG. 11, when the antecedent calculation instruction INSe outputs the release notification FREE at the cycle after the X cycle, the subsequent calculation instruction INSe also outputs the release notification FREE at the clock cycle after the X cycle. As a result, the counter COUNTe may decrement the counter value for every release notification FREE, and the reservation station RSE may release one entry ENTe for every release notification FREEe. That is to say, the circuit configuration control of the reservation station RSE and the counter COUNTe may be simpler than when multiple release notifications FREEe overlap when output.

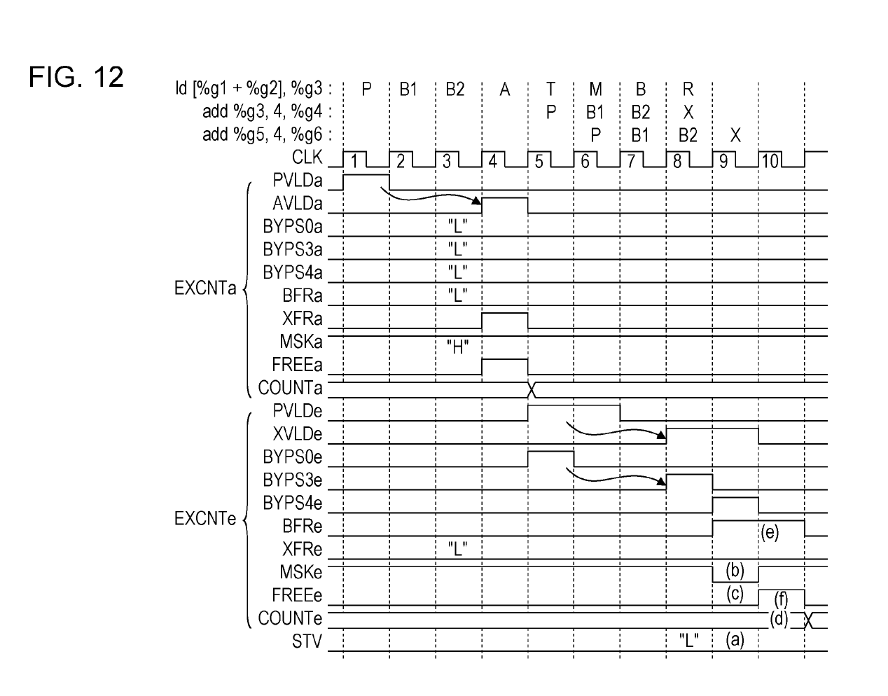

FIG. 12 is a diagram illustrating another operation example of the calculation processing device OPD including the core unit CORE illustrated in FIG. 3. That is to say, FIG. 12 illustrates a method for controlling the calculation processing device OPD. The operations that are the same as or similar to that in FIGS. 8 and 11 are not described in detail.

According to this example, the executing unit EUNIT sequentially executes the same instructions (5), (6), and (7) as in FIG. 11, that is to say, the load instruction Id and the add instruction add. However, during the T cycle of the load instruction Id, the control circuit DCCNT in the storage unit MUNIT determines cache misses, and outputs access requests to the secondary cache L2. For this reason, the control circuit DCCNT does not generate the completion notification STV at the ninth clock cycle ((a) of FIG. 12).

In FIG. 12, the operation of the executing control unit EXCNTa is the same as or similar to that in FIG. 9, and the operation of the executing control unit EXCNTe is the same as or similar to that in FIG. 11, excluding the operation of the mask signal MSKe, release notification FREEe, and the counter COUNTe.

The mask circuit FMSKe in the executing control unit EXCNTe receives the bypass signal BYPS4e at a high level and the completion notification STV at a low level at the ninth clock cycle, and sets the mask signal MSKe at a low level ((b) of FIG. 12. As a result, the mask circuit FMSKe disables the AND circuit AND5, and stops the generation of the release notification FREEe based on the release signal BFRe ((c) of FIG. 12).

As the release notification FREEe is not received, the reservation station RSE maintains the set state of the valid flag V for the entry ENTe holding the add instruction add currently executing. Thus, when the release notification FREEe is not generated, the entry ENTe in the reservation station RSE is not released. The counter COUNTe in the decoder unit DEC also does not receive the release notification FREEe, and so maintains the count value ((d) of FIG. 12). Further, the wave forms of the release signal BFRe and FREEe generated at the tenth clock cycle based on the second add instruction add are the same as that in FIG. 11 ((e and f) of FIG. 12).

The address generating unit EAG does not receive the completion notification STV at the ninth clock cycle. In contrast, the reservation station RSA releases the entry ENTa holding the load instruction Id due to the release notification FREEe generated at the fourth clock cycle. As the reservation station RSA is not holding the load instruction Id, the load instruction Id is not re-input into the address generating unit EAG.

The control circuit DCCNT and address generating unit EAG in the storage unit MUNIT cancel the execution result from the T cycle, the M cycle, the B cycle, and the R cycle of the load instruction Id. The control circuit DCCNT and the address generating unit EAG also re-execute the T cycle, the M cycle, the B cycle, and the R cycle of the load instruction Id after writing the data from the secondary cache L2 to the data cache DCACHE.

In contrast, as the release notification FREEe corresponding to the first add instruction add is not generated, the reservation station RSE continues to hold the add instruction add. For this reason, the reservation station RSE re-inputs the first add instruction add is re-input into the calculating unit FEU after the data is written from the secondary cache L2 into the data cache DCACHE.

When the completion notification STV is not output in this way, the add instruction add may be re-input into the executing unit EUNIT from the reservation station RSE by stopping the output of the release notification FREEe and stopping the release of the entry ENTe holding the corresponding add instruction add. The desired data may also be obtained by the recalculating the data, which is read from the storage unit MUNIT by the resumed load instruction Id, with the re-input add instruction add.

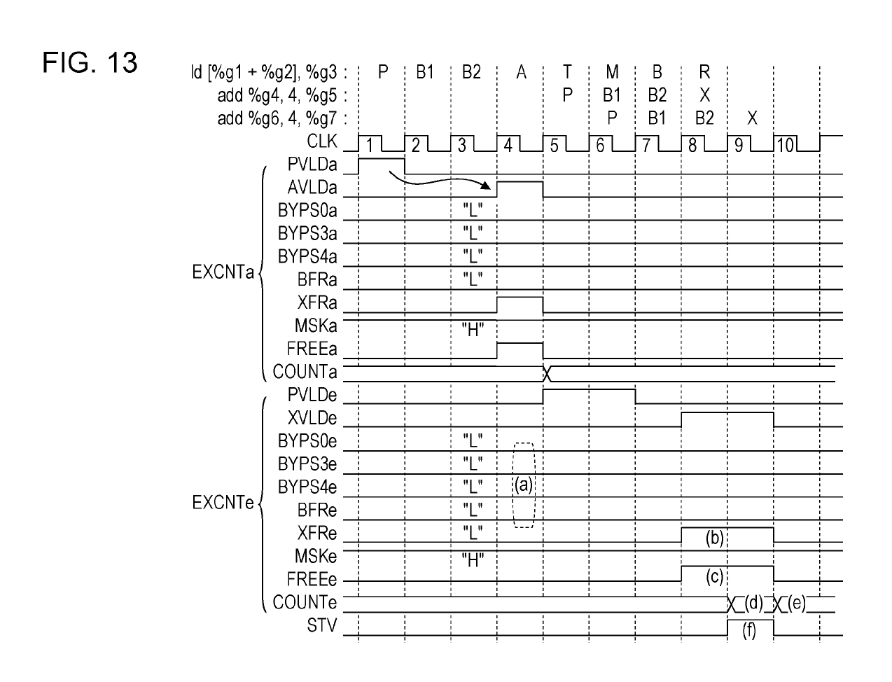

FIG. 13 is diagram illustrating another operation example of the calculation processing device OPD including the core unit CORE illustrated in FIG. 3. That is to say, FIG. 13 illustrates a method for controlling the calculation processing device OPD. The operations that are the same as or similar to that in FIGS. 8 and 11 are not described in detail.

According to this example and similar to FIG. 11, the load instruction Id and the two add instructions add are sequentially input into the executing unit EUNIT from the reservation station RSA and RSE. The executing unit EUNIT sequentially executes the load instruction Id and the two add instructions add as represented by instructions (8), (9), and (10).

Id[% g1+% g2],% g3 (8)

add % g4,4,% g5 (9)

add % g6,4,% g7 (10)

The instruction (8) is the same as the previously described instruction (1). The instructions (9) and (10) are add instructions add that are similar to the previously described instruction (6). For example, registers g3 through g7 are general purpose registers provisioned in the register unit REG illustrated in FIG. 3.

According to the instructions (8) and (9) in this example, the execution cycle of the T cycle of the load instruction Id and the P cycle of the add instruction add are the same, but as there is no dependent relationship between the registers used, the bypass processing is not executed. According to the instructions (8) and (10), the execution cycle of the T cycle of the load instruction Id and the P cycle of the add instruction add are different, and there is also no dependent relationship between the registers used, and so the bypass processing is not executed.

In FIG. 13, the operation of the executing control unit EXCNTa is the same as or similar to that in FIG. 9. The operation of the executing control unit EXCNTe is the summation of the waveform illustrated in FIG. 9 and the waveform illustrated in FIG. 10.

According to this example, the bypass processing is not executed regarding the two add instructions add, and so the bypass signal BYPS0e, BYPS3e, and BYPS4e, and the release signal BFRe are maintained at a low level similar to that in FIG. 9 ((a) of FIG. 13).

The signal generator FGENe1 receives the release signal BFRe at a low level and the bypass signal BYPS3e at a low level, and enables the AND circuit AND3 and AND4 during the eighth and ninth clock cycles. The signal generator FGENe1 also sets the release signal XFRe at a high level based on the valid signal XVLDe at a high level ((b) of FIG. 13).

The mask signal MSKe is maintained at a high level by the bypass signal BYPS4e at a low level during the eighth and ninth clock cycles. For this reason, the mask circuit FMSKe sets the release notification FREEe at a high level on the basis of the release signal XFRe at a high level ((c) of FIG. 13).

The counter COUNTe in the decoder unit DEC receives the release notification FREEe during the eighth and ninth clock cycles, and decrements the count value by one with each signal received ((d and e) of FIG. 13). The control circuit DCCNT in the storage unit MUNIT illustrated in FIG. 3 outputs the completion notification STV during the R cycle of the load instruction Id ((f) of FIG. 13).

When the bypass processing is not executed regarding the two add instructions add continuing after the load instruction Id in this way, the executing control unit EXCNTe outputs the release notification FREEe corresponding to each add instruction add at the X cycle of each add instruction add. As the release notifications FREEe do not overlap when output, similar to that in FIG. 11, the circuit configuration and control of the counter COUNTe and the reservation station RSE may be simpler than when the release notifications FREEe overlap when output.

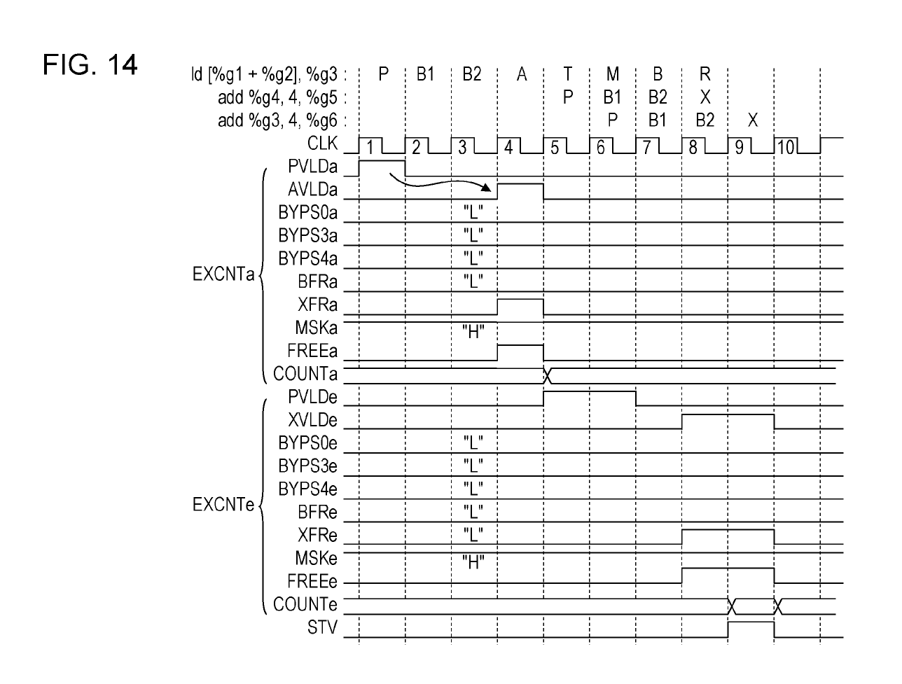

FIG. 14 is a diagram illustrating another operation example of the calculation processing device OPD including the core unit CORE illustrated in FIG. 3. That is to say, FIG. 14 illustrates a method for controlling the calculation processing device OPD. The operations that are the same as or similar to that in FIGS. 8, 11, and 13 are not described in detail.

According to this example and similar to FIG. 13, the load instruction Id and the two add instructions add are sequentially input into the executing unit EUNIT from the reservation station RSA and RSE. The executing unit EUNIT sequentially executes the load instruction Id and the two add instructions add as represented by instructions (11), (12), and (13).

Id[% g1+% g2],% g3 (11)

add % g4,4,% g5 (12)

add % g3,4,% g6 (13)

The instruction (11) is the same as the previously described instruction (1), and the instruction (12) is the same as the previously described instruction (9). According to the instructions (11) and (12) in this example, the execution cycle of the T cycle of the load instruction Id and the P cycle of the add instruction add are the same, but as there is no dependent relationship between the registers used, the bypass processing is not executed. According to the instructions (11) and (13), the same register g3 is used, but the execution cycle of the T cycle of the load instructions Id and the P cycle of the add instruction add are different, and there is also no dependent relationship between the registers, and so the bypass processing is not executed. For this reason, the operation as in FIG. 14 is similar to that in FIG. 13.

That is to say, regarding the two add instructions add continuing from the load instruction Id, when the antecedent calculation instruction INSe is bypass processed, and the subsequent calculation instruction INSe is not bypass processed, the release notification FREEe is output at the X cycle of each add instruction add. As a result, which is similar to that in FIGS. 11 and 13, the circuit configuration and control of the reservation station RSE and the counter COUNTe may be simpler than when the release notification FREEe overlaps when output.

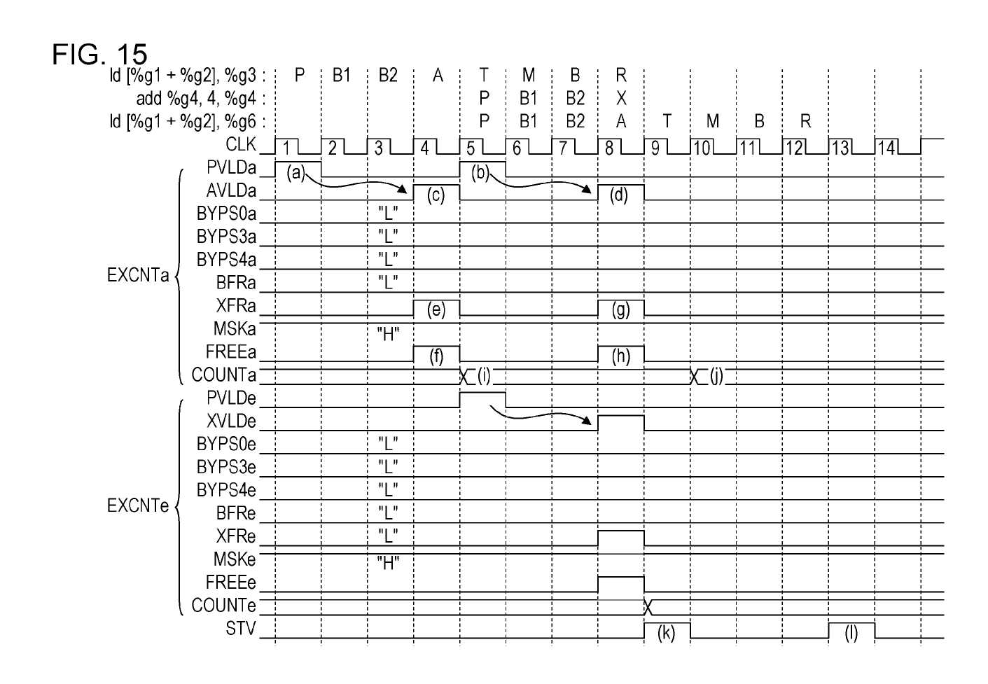

FIG. 15 is a diagram illustrating another operation example of the calculation processing device OPD including the core unit CORE illustrated in FIG. 3. That is to say, FIG. 15 illustrates a method for controlling the calculation processing device OPD. The operations that are the same as or similar to that in FIGS. 8 and 9 are not described in detail.

According to this example, the load instruction Id, the add instruction add, and another load instruction Id are sequentially input into the executing unit EUNIT from the reservation station RSA and RSE. The executing unit EUNIT sequentially executes the load instruction Id, the add instruction add, and the other load instruction Id as represented by instructions (14), (15), and (16).

Id[% g1+% g2],% g3 (14)

add % g4,4,% g4 (15)

Id[% g1+% g2],% g6 (16)

The instructions (14) and (16) are the same as the previously described instructions (3) and (4). The instruction (16) is the same as the instruction (14) excluding the different registers to which the loaded data is stored.

According to the instructions (14) and (15) and similar to the previously described instructions (3) and (4), the execution cycle of the T cycle of the load instruction Id and the P cycle of the add instruction add are the same, but as there is no dependent relationship between the registers used, the bypass processing is not executed. According to the instructions (14) and (16), the execution cycle of the T cycle of the antecedent load instruction Id and the P cycle of the subsequent load instruction Id are the same. However, the destination register (register storing the data from the R (result) cycle) for the antecedent load instruction Id and the source register (register used for the calculation of the access address AD at the A (address) cycle) for the subsequent load instruction Id are different. That is to say, there is no dependent relationship between the registers used, and so the bypass processing is also not executed regarding the instructions (14) and (16).

The operation of the executing control unit EXCNTe is similar to that in FIG. 9. According to this example, the two load instructions Id are pipeline processed, and so the executing control unit EXCNTa generates the valid signal PVLDa at the first and fifth clock cycles, and generates the valid signal AVLDa at the fourth and eighth clock cycles ((a, b, c, and d) of FIG. 15). The executing control unit EXCNTa also generates the release signal XFRa and FREEa at the fourth and eighth clock cycles corresponding to the A cycle of the load instruction Id ((e, f, g, h) of FIG. 15).

The reservation station RSA resets the valid flag V, and sequentially releases one entry ENTa on the basis of each pulse from the release notification FREEa. The counter COUNTa in the decoder unit DEC decrements the count value by one on the basis of each pulse from the release notification FREEa ((i and J) of FIG. 15). Further, the control circuit DCCNT in the storage unit MUNIT illustrated in FIG. 3 outputs the completion notification STV during the R cycle of each load instruction Id ((k and l) of FIG. 15).

When the bypass processing is not executed during the antecedent load instruction Id and the subsequent load instruction Id in this way, the release notification FREEa is output at the A cycle of each load instruction Id. The counter COUNTa decrements the count value on the basis of each release notification FREEa, and the reservation station RSA releases the entry ENTa on the basis of each release notification FREEa. Further, when there is no add instruction add in between the two load instructions Id, the executing control unit EXCNTa operates similar to that in FIG. 15.

FIG. 16 is a diagram illustrating another example operation of the calculation processing device OPD including the core unit CORE in FIG. 3. That is to say, FIG. 16 illustrates a method for controlling the calculation processing device OPD. The operations that are the same as or similar to that in FIGS. 8, 9, and 15 are not described in detail.

According to this example and similar to that in FIG. 15, the load instruction Id, the add instruction add, and another load instruction Id are sequentially input into the executing unit EUNIT from the reservation station RSA and RSE. The executing unit EUNIT sequentially executes the load instruction Id, the add instruction add, and the other load instruction Id as represented by instructions (17), (18), and (19).

Id[% g1+% g2],% g3 (17)

add % g4,4,% g4 (18)

Id[% g3+% g2],% g6 (19)

The instructions (17) and (18) are the same as the previously described instructions (3) and (4). The instruction (19) is similar to the instruction (17) excluding the different registers storing the loaded data.

According to the instructions (17) and (18) and similar to the previously described instructions (3) and (4), the bypass processing is not executed. According to the instructions (17) and (19), the execution cycle of the T cycle of the antecedent load instruction Id and the P cycle of the subsequent load instruction Id are the same. Also, the destination register (register storing the data at the R cycle) for the antecedent load instruction Id and the source register (register used in the calculation of the access address AD at the A cycle) for the subsequent load instruction Id are the same. That is to say, the two load instructions Id have a dependent relationship between the registers. For this reason, the bypass processing is executed regarding the instructions (17) and (19).

The operation of the executing control unit EXCNTe is similar to than in FIGS. 9 and 15. The operation of the executing control unit EXCNTa up to the seventh clock cycle is similar to that in FIG. 15. The waveform of the valid signal PVLDa and AVLDa generated by the executing control unit EXCNTa is similar to that in FIG. 15. The cycle generator CGENa2 in the executing control unit EXCNTa determines whether to execute the bypass processing based on the comparison result by the comparator circuit CMPa. The cycle generator CGENa2 also generates the bypass signal BYPS0a, BYPS3a, and BYPS4a at the fifth, eighth, and ninth clock cycles, respectively ((a, b, and c) of FIG. 16).

The signal generator FGENa1 in the executing control unit EXCNTa receives the bypass signal BYPS3a at a high level at the eighth clock cycle, and the AND circuit AND3 stops the transfer of the valid signal AVLDa. As a result, the release signal XFRa and the release notification FREEa are not generated during the R cycle of the antecedent load instruction Id ((d and e) of FIG. 16).

The signal generator FGENa2 generates the release signal BFRa at the ninth clock cycle based on the bypass signal BYPS3a at a high level and the valid signal AVLDa at a high level generated at the eighth clock cycle ((f) of FIG. 16). The release signal BFRa is supplied to the AND circuit AND5 in the mask circuit FMSKa.

The NAND circuit NAND1 in the mask circuit FMSKa receives the bypass signal BYPS4a at a high level at the ninth cycle, and also receives the inverted signal of the completion notification STV at a high level at the ninth clock cycle ((g) of FIG. 16). The NAND circuit NAND1 maintains the mask signal MSKa at a high level based on the completion notification STV at a high level, and enables the and circuit AND5 ((h) of FIG. 16). The AND circuit AND5 outputs the release signal BFRa at a high level as the release notification FREEa based on the mask signal MSKa at a high level ((i) of FIG. 16).

The reservation station RSA receives the release notification FREEa, resets the valid flag V for the entry ENTa holding the subsequent load instruction Id, which has finished executing, and releases one entry ENTa. As a result, the number of access instructions INSa held in the reservation station RSA is decreased by one. The counter COUNTa in the decoder unit DEC receives the release notification FREEa and decrements the count value ((j) of FIG. 16).

When the bypass processing is executed during the antecedent load instruction Id and the subsequent load instruction Id in this way, the release notification FREEa corresponding to the subsequent load instruction Id is output at the clock cycle after the A cycle of the subsequent load instruction Id. As a result, the release notification FREE may be output combined with the output of the completion notification STV from the storage unit MUNIT, the count value of the counter COUNTa may be decremented, and the entry ENTa may be released. Further, when there is no add instruction add between the two load instructions Id, the executing control unit EXCNTa operates similar to that in FIG. 16.

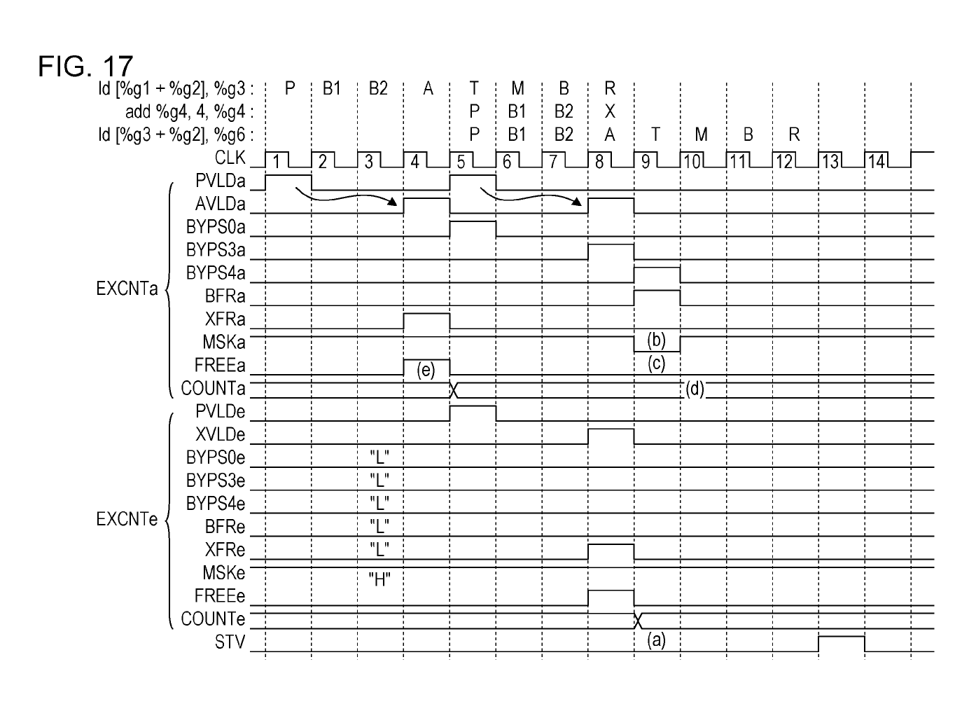

FIG. 17 is a diagram illustrating another operation example of the calculation processing device OPD including the core unit CORE illustrated in FIG. 3. That is to say, FIG. 17 illustrates a method for controlling the calculation processing device OPD. The operations that are similar to or the same as that in FIGS. 8, 9, 12, and 16 are not described in detail.

According to this example, the executing unit EUNIT sequentially executes the same instructions (17), (18), and (19) as that in FIG. 16, that is to say, the load instruction Id, the add instruction add, and another load instruction Id. However, the control circuit DCCNT in the storage unit MUNIT determines a cache miss during the T cycle of the antecedent load instruction Id, and outputs an access request to the secondary cache L2. For this reason, the control circuit DCCNT does not generate the completion notification STV at the ninth clock cycle ((a) of FIG. 17).

In FIG. 17, the operation of the executing control unit EXCNTe is the same as or similar to that in FIG. 16, and the operation of the executing control unit EXCNTa is the same as or similar to that in FIG. 16, excluding the operation of the mask signal MSKa, the release notification FREEa, and the counter COUNTa.

The mask circuit FMSKa in the executing control unit EXCNTa receives the completion notification STV at a low level and the bypass signal BYPS4a at a high level at the ninth clock cycle, and sets the mask signal MSKa at a low level ((b) of FIG. 17). As a result, The mask circuit FMSKa disables the AND circuit AND5, and stops the generation of the release notification FREEa based on the release signal BFRa ((c) of FIG. 17).

As the reservation station RSA does not receive the release notification FREEa, the set state of the valid flag V for the entry ENTa holding the subsequent load instruction Id is maintained. When the release notification FREEa is not generated in this way, the entry ENTa in the reservation station RSA is not released. The counter COUNTa in the decoder unit DEC also does not receive the release notification FREEa, and so maintains the count value ((d) in FIG. 17). However, the entry ENTa holding the antecedent load instruction Id in the reservation station RSA is released on the basis of the release notification FREEa generated at the fourth clock cycle ((e) of FIG. 17).

Similar to that in FIG. 12, the reservation station RSA releases the entry ENTa holding the antecedent load instruction Id by the release notification FREEa generated at the fourth clock cycle. For this reason, the antecedent load instruction Id is not re-input into the address generating unit EAG from the reservation station RSA.

The control circuit DCCNT and the address generating unit EAG in the storage unit MUNIT cancel the execution result from the T cycle, the M cycle, the B cycle, and the R cycle of the antecedent load instruction Id. The control circuit DCCNT and the address generating unit EAG also re-execute the T cycle, the M cycle, the B cycle, and the R cycle of the antecedent load instruction Id after the data from the secondary cache L2 is written to the data cache DCACHE.

In contrast, the release notification FREEa corresponding to the subsequent load instruction Id is not generated, and so the reservation station RSA continues to hold the subsequent load instruction Id. For this reason, the subsequent load instruction Id is re-input into the address generating unit EAG from the reservation station RSA after the data from the secondary cache L2 is written into the data cache DCACHE by the antecedent load instruction Id.

When the completion notification STV is not output in this way, the load instruction Id may be re-input into the executing unit EUNIT from the reservation station RSA by stopping the output of the release notification FREEa and stopping the release of the entry ENTa holding the corresponding load instruction Id. The data read from the storage unit MUNIT by the continuing load instruction Id may be used in the calculation of the access address regarding the re-input load instruction Id.

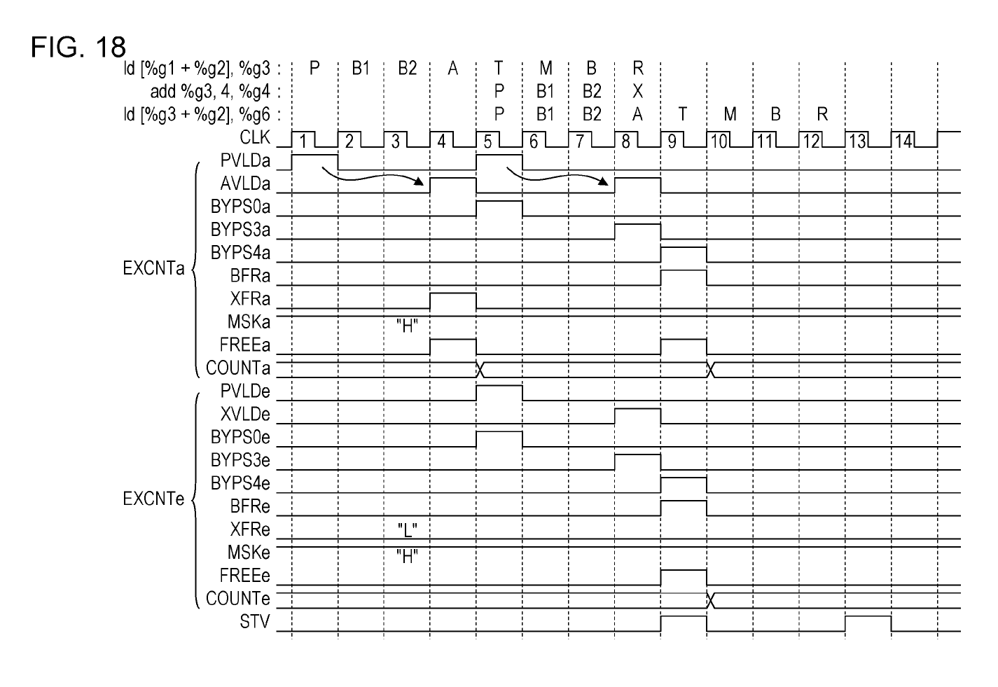

FIG. 18 is a diagram illustrating another operation example of the calculation processing device OPD including the core unit CORE illustrated in FIG. 3. That is to say, FIG. 18 illustrates a method for controlling the calculation processing device OPD. The operations that are the same as or similar to that in FIGS. 8 and 16 are not described in detail.

According to this example, the load instruction Id, the add instruction add, and another load instruction Id is sequentially input into the executing unit EUNIT from the reservation station RSA and RSE similar to FIG. 16. The executing unit EUNIT sequentially executes the load instruction Id, the add instruction add, and the other load instruction Id as represented by instructions (20), (21), and (22).

Id[% g1+% g2],% g3 (20)

add % g3,4,% g4 (21)

Id[% g3+% g2],% g6 (22)

The instructions (20) and (21) are the same as the instructions (1) and (2). The instruction (22) is similar to the previously described instruction (19). According to the instructions (20) and (21), the add instruction add executes a calculation using the data read from the register g3 produced by the antecedent load instruction Id. That is to say, the registers used by the instructions (20) and (21) have a dependent relationship. The execution cycle of the T cycle of the antecedent load instruction Id and the P cycle of the add instruction add are the same, and so the bypass processing is executed. The operation of the executing control unit EXCNTe is similar to that in FIG. 16.

According to the instructions (20) and (22), the execution cycle of the T cycle of the antecedent load instruction Id and the P cycle of the subsequent load instruction Id are the same. The destination register of the antecedent load instruction Id and the source register of the subsequent load instruction Id are also the same. For this reason, there is also a dependent relationship regarding registers between the instructions (20) and (22), and so the bypass processing is executed. The operation of the executing control unit EXCNTa is similar to that in FIG. 8.

According to FIGS. 8 through 18, the examples were described using the add instruction add as the calculation instruction INSe, but the calculation instruction INSe executed may be a subtraction instruction, a shift instruction, or a logical calculation instruction such as an AND instruction and an OR instruction.

Thus, similar to the previously described embodiments, according to the present embodiment, when the bypass processing is not executed during the access instruction INSa and the calculation instruction INSe, the release notification FREEe may be output one clock cycle earlier than that of the related art. For this reason, the count value of the counter COUNTe may be decremented earlier than that of the related art, and the aggregate number of calculation instructions INSe that may be held in the reservation station RSE during a predetermined period may be increased as compared to the related art.

When the bypass processing is not executed during the two access instructions INSa, the release notification FREEa may also be output one clock cycle earlier than that of the related art. For this reason, the count value of the counter COUNTa may be decremented earlier than that of the related art, and the aggregate number of calculation instructions INSa that may be held in the reservation station RSA during a predetermined period may be increased as compared to the related art.

As a result the utilization efficiency of the instruction holding unit RSA may be improved, and the performance of the calculation processing device OPD may be improved.

There are cases when the bypass processing is executed for the antecedent calculation instruction INSe from among two calculation instructions INSe following the access instruction INSa, but the bypass processing is not executed for the subsequent calculation instruction INSe. In this case, the release notification FREEe corresponding to the antecedent calculation instruction INSe as well as the release notification FREEe corresponding to the subsequent calculation instruction INSe may both be output at the clock cycle after the X cycle.

Also, there are cases when the bypass processing is not executed for the antecedent calculation instruction INSe from among two calculation instructions INSe following the access instruction INSa, but the bypass processing is executed for the subsequent calculation instruction INSe, or when the bypass processing is not executed for both of the calculation instructions INSe. In these cases, the release notification FREEe corresponding to each calculation instruction INSe may be output at the X cycle.

The executing control unit EXCNTe executes control so that the release notification FREEe of the two calculation instructions INSe are not output at the same clock cycle regardless of the whether or not the bypass processing was executed, and so the circuit configuration and control of the counter COUNTe and the reservation station RSE may be simpler than when the release notification FREEe overlaps when output.

Also, when the executing control unit EXCNTe changes the output timing of the release notification FREEe depending on the bypass processing, and the completion notification STV is not output, the executing control unit EXCNTe may still stop the output of the release notification FREEe. As a result, the removal of the calculation instruction INSe, which has not finished executing, from the reservation station RSE may be inhibited, and the calculation instruction INSe may be re-input into the executing unit EUNIT from the reservation station RSE.

Similarly, when the executing control unit EXCNTa changes the output timing of the release notification FREEa depending on the bypass processing, and the completion notification STV is not output, the executing control unit EXCNTa may still stop the output of the release notification FREEa. As a result, the removal of the access instruction INSa, which has not finished executing, from the reservation station RSA may be inhibited, and the access instruction INSa may be re-input into the executing unit EUNIT from the reservation station RSA.

The previous detailed description makes the features and advantages of the embodiments clear. It is intended that the features and advantages of the previously described embodiments do not depart from the scope and spirit of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A calculation processing device comprising:
a decoder unit including,
a first counter configured to increment a first count value when decoding an instruction of a first class and to decrement the first count value when a first release notification is input, and
a second counter configured to increment a second count value when decoding an instruction of a second class and to decrement the second count value when a second release notification is input;
a first instruction executing unit configured to execute an instruction of the first class;
a second instruction executing unit configured to execute an instruction of the second class;
a first instruction holding unit including a plurality of first entries for holding the instructions of the first class, configured to input the instruction of the first class held in one of the plurality of first entries into the first instruction executing unit;
a second instruction holding unit including a plurality of second entries for holding the instructions of the second class, configured to input the instruction of the second class held in one of the plurality of second entries into the second instruction executing unit; and
a first control unit configured to output the second release notification when the instruction of the second class input into the second instruction executing unit is finished executing, and to change the output timing of the second release notification when a predetermined relationship is established between the timing when an antecedent instruction of the first class input into the first instruction executing unit finishes executing and the timing when a subsequent instruction of the second class input into the second instruction executing unit finishes executing, and the register to which the antecedent instruction of the first class writes the calculation result is used by the subsequent instruction of the second class.

2. The calculation processing device according to claim 1,
wherein the first control unit outputs the second release notification at the next cycle after the cycle in which the instruction of the second class finishes executing when the subsequent instruction of the second class input into the second instruction executing unit finishes executing at the same cycle in which the antecedent instruction of the first class input into the first instruction executing unit finishes executing, and the register to which the antecedent instruction of the first class writes the calculation result is used by the subsequent instruction of the second class.

3. The calculation processing device according to claim 1,
wherein the first control unit outputs the second release notification at the cycle in which the instruction of the second class finishes executing when the subsequent instruction of the second class input into the second instruction executing unit finishes executing at a different cycle in which the antecedent instruction of the first class input into the first instruction executing unit finishes executing, or when the register to which the antecedent instruction of the first class writes the calculation result is not used by the subsequent instruction of the second class.

4. The calculation processing device according to claim 2,
wherein the first control unit outputs the second release notification corresponding to another instruction of the second class at the next cycle after the cycle in which the instruction of the second class finishes executing, when another instruction of the second class following the subsequent instruction of the second class input into the second instruction executing unit finishes executing, at the next cycle after the cycle in which the antecedent instruction of the first class input into the first instruction executing unit finishes executing.

5. The calculation processing device according to claim 1 further comprising:
a second control unit configured to output the first release notification when the instruction of the first class input into the first instruction executing unit is finished executing, and to change the output timing of the first release notification when a predetermined relationship is established between the timing when an antecedent instruction of the first class is input into the first instruction executing unit finishes executing and the timing when subsequent instruction of the first class is input into the first instruction executing unit finishes executing, and the register to which the antecedent instruction of the first class writes the calculation result is used by the subsequent instruction of the first class.

6. The calculation processing device according to claim 5 further comprising:
a storage unit configured to output data accessed on the basis of the instruction of the first class, wherein
the second control unit outputs the first release notification at the next cycle after the cycle in which the antecedent instruction of the first class finishes executing when the subsequent instruction of the first class input into the first instruction executing unit calculates the access address of the storage unit using the data stored in a register at the same cycle in which the antecedent instruction of the first class input into the first instruction executing unit finishes executing, and the register to which the antecedent instruction of the first class writes the calculation result is used by the subsequent instruction of the first class in calculating the access address.

7. The calculation processing device according to claim 2 further comprising:
a storage unit configured to output data accessed on the basis of the instruction of the first class, and to output a completion notification at the cycle in which the output of the data completes,
wherein the first control unit outputs the second release notification at the next cycle after the subsequent instruction of the second class finishes executing after receiving the completion notification at the next cycle after the cycle in which the output of data completes, and stops the output of the second release notification when the completion notification is not received at the next cycle after the cycle in which the output of data completes.

8. The calculation processing device according to claim 1,
wherein the first instruction holding unit releases a first entry holding an instruction of the first class corresponding to the release notification when the first release notification is input.

9. The calculation processing device according to claim 1,
wherein the second instruction holding unit releases a second entry holding an instruction of the second class corresponding to the release notification when the second release notification is input.

10. A method for controlling a calculation processing device, the calculation processing device including
a first instruction holding unit provisioned with a plurality of first entries for holding instructions of a first class,
a second instruction holding unit provisioned with a plurality of second entries for holing instructions of a second class,
a first instruction executing unit for executing the instructions of the first class, and
a second instruction executing unit for executing the instructions of the second class,
the method comprising:
a first counter provisioned in a decoder unit included in the calculation processing device incrementing a first count value when decoding an instruction of the first class;
a second counter provisioned in the decoder unit incrementing a second count value when decoding an instruction of the second class;
the first instruction holding unit inputting an instruction of the first class held in any of the plurality of first entries into the first instruction executing unit;
the second instruction holding unit inputting an instruction of the second class held in any of the plurality of second entries into the second instruction executing unit;
a control unit provisioned in the calculation processing device outputting the second release notification when the instruction of the second class input into the second instruction executing unit is finished executing, and changing the output timing of the second release notification when a predetermined relationship is established between the timing when an antecedent instruction of the first class is input into the first instruction holding unit finishes executing and the timing when a subsequent instruction of the second class is input into the second instruction executing unit finishes executing, and the register to which the antecedent instruction of the first class writes the calculation result is used by the subsequent instruction of the second class;
the first counter decrementing the first count value when a first release notification is input; and
the second counter decrementing the second count value when a second release notification is input.
